(19) United States
(12) Patent Application Publication
(10) Pub. No.: US 2025/0210064 A1
(43) Pub. Date: Jun. 26, 2025

(54) SYSTEM AND METHODS FOR REMOTE CAPTURE AND AUTOMATED DIRECTING OF CUSTOMIZED AND EDITABLE VIDEO SEGMENTS

(71) Applicant: Rolla Labs Inc., New York, NY (US)

(72) Inventors: Casey McGuire, El Portal, FL (US); Jesse Senger, Brooklyn, NY (US)

(73) Assignee: Rolla Labs Inc., New York, NY (US)

(21) Appl. No.: 18/991,326

(22) Filed: Dec. 20, 2024

Related U.S. Application Data
(60) Provisional application No. 63/612,953, filed on Dec. 20, 2023.

(51) Int. Cl. G11B 27/034

(52) U.S. Cl. CPC G11B 27/034

(57) ABSTRACT

Provided is a method for generating a storyboard, the method comprising retrieving user-specific information from a user, wherein the user-specific information is correlated to a prospective video; collecting, based on the user-specific information, via a data pipeline in informatic communication with a platform application programming interface, content from a platform; preprocessing the content from the platform to manifest preprocessed content; feeding the preprocessed content into a storyboard generation module; generating, via a machine learning model, the storyboard based on the preprocessed content, wherein the machine learning model was trained on a training dataset selected from the group consisting of preexisting videos and preexisting storyboards; and displaying the storyboard, via a storyboard interface, the storyboard interface comprising one or more user-editable options for the storyboard.

### CROSS-REFERENCE TO RELATED APPLICATIONS

This application claims the benefit of U.S. Provisional Patent Application No. 63/612,953, filed on Dec. 20, 2023, which is incorporated by reference herein in its entirety.

### FIELD OF THE DISCLOSURE

The present disclosure is generally directed to a storyboard generation system capable of using artificial intelligence (hereinafter “AI”) and other computer-implemented means to generate unique video storyboard outlines.

### INTRODUCTION

It is imperative for businesses and consumers to enhance their visual presence and augment revenue through audiovisual content. However, the avenues available for video creation present formidable challenges. The initial option, which entails engaging a production company, is fraught with hurdles—be it the substantial financial investment, the intricate logistics involved, or the inevitable delays stemming from the complexities of scheduling. As such, a production company is not practical or realistic for most people or small businesses. Conversely, the second option necessitates users to create their own videos, only to grapple with dilemmas associated with the utilization of audiovisual editing programs, cinematography, etc.

Regrettably, the majority of audiovisual editing software currently accessible falls short of meeting a user's needs, requiring substantial investments in both time and effort to refine raw video content, all while lacking the crucial guidance of storyboarding. Such a deficiency leads to subpar content, posing a significant barrier in the quest to transform said raw video content into high-quality and engaging videos. Users often find themselves trapped in a state of creation paralysis, grappling with uncertainty regarding how to initiate or cultivate a compelling narrative.

Acknowledging the inherent limitations of existing solutions, a distinct opportunity arises to pioneer a novel system and method. Thus, it would be desirable to automatically assess the subject matter of a given video, and usher in a seamless process to generate a meticulously crafted storyboard to aid users in organizing and generating audiovisual content.

### SUMMARY

Aspects of the present disclosure relate to a method for generating a storyboard, the method including: generating, via a server, a storyboard template including one or more suggested scenes, wherein each suggested scene of the one or more suggested scenes includes at least one directive prompt; transmitting, via a network, the storyboard template to a frontend; capturing, based on the storyboard template including the one or more suggested scenes, content on the frontend, wherein the content includes the one or more suggested scenes; receiving, at the server, the content including the one or more suggested scenes; and generating, based on the content including the one or more scenes, a storyboard.

Aspects of the present disclosure relate to a method, wherein the method further includes transmitting, via the server, a notification to the frontend instructing a user to configure the frontend to capture the content.

Aspects of the present disclosure relate to a method, the step of generating, based on the content including the one or more scenes, a storyboard further including utilizing a machine learning algorithm to generate the storyboard, wherein the machine learning algorithm is trained on a training dataset selected from a group including preexisting content and preexisting storyboards generated from the preexisting content.

Aspects of the present disclosure relate to a method, wherein the machine learning algorithm is further trained based on historical user behavior and/or predefined brand preferences.

Aspects of the present disclosure relate to a method, wherein the frontend includes a display, and wherein the display is configured to display guardrail settings to the user, the guardrail settings including a directive prompt and a corrective prompt.

Aspects of the present disclosure relate to a method, wherein the method further includes: tracking data of a hardware component of the frontend, the hardware component including any of an accelerometer, a gyroscope, a microphone, and a light sensor; determining, based on the data of the hardware component, the scene of the one or more scenes is not within a threshold of the guardrail settings; displaying on the display the corrective prompt.

Aspects of the present disclosure relate to a method, wherein the frontend automatically transmits the content to the server when the content is generated.

Aspects of the present disclosure relate to a method for directing the capture of user content, the method including: transmitting, via a network, a storyboard template to frontend, the storyboard template including a plurality of suggested scenes, wherein each suggested scene of the plurality of suggested scenes includes guardrail settings, the guardrail settings for each of the suggested scenes including: one or more directive prompts configured to direct a user in capturing content; and a plurality of corrective prompts; monitoring the frontend, wherein the frontend is actively capturing user content; determining the user content being captured by the frontend is outside a threshold of the guardrail settings; and displaying, in response to determining the user content is outside the threshold of the guardrail settings, on a display of the frontend at least one corrective prompt of the plurality of corrective prompts.

Aspects of the present disclosure relate to a method, the method further including transmitting, to the frontend, a notification including directions to begin capturing the content of a subject.

Aspects of the present disclosure relate to a method, wherein the guardrail settings further include any of a shot style, a shot view, a camera choice, a script, a suggested scene order, a maximum recording length, an acceleration, an orientation, a light level, and a sound level.

Aspects of the present disclosure relate to a method, wherein monitoring the frontend actively capturing user content includes monitoring any of an accelerometer, a gyroscope, a light sensor, and a microphone of the frontend.

Aspects of the present disclosure relate to a method, wherein at least one corrective prompt of the plurality of corrective prompts is configured to be displayed on the frontend upon the gyroscope detecting the frontend being tilted beyond the threshold of the guardrail settings.

Aspects of the present disclosure relate to a method, wherein at least one corrective prompt of the plurality of corrective prompts is configured to be displayed on the frontend upon the accelerometer detecting the frontend is experiencing an excess of movement.

Aspects of the present disclosure relate to a method, wherein at least one corrective prompt of the plurality of corrective prompts is configured to be displayed on the frontend upon the light sensor detecting an ambient light being too low.

Aspects of the present disclosure relate to a method, wherein at least one corrective prompt of the plurality of corrective prompts is configured to be displayed on the frontend upon the microphone detecting an ambient noise level being too high.

Aspects of the present disclosure relate to a method for generating a final video based on user-generated content, the method including: transmitting, via a network, a plurality of storyboard templates including a plurality of suggested scenes, wherein each suggested scene of the plurality of suggested scenes includes a directive prompt configured to communicate scene capturing directions; receiving, at a server, a plurality of complete storyboards including a first complete storyboard and a second complete storyboard, wherein each complete storyboard of the plurality of complete storyboards includes a plurality of scenes of user-generated content based on the directive prompts; storing the plurality of complete storyboards in a content management system; generating, via the content management system, a final video including at least a portion of a first plurality of scenes of user-generated content of the first complete storyboard and at least a portion of a second plurality of scenes of user-generated content of the second complete storyboard.

Aspects of the present disclosure relate to a method, wherein the content management system includes a machine learning algorithm configured to automatically generate the final video, wherein the machine learning algorithm is trained on a training dataset selected from a group including preexisting scenes and preexisting complete storyboards generated from the preexisting scenes.

Aspects of the present disclosure relate to a method, wherein the method is repeated to create a plurality of final videos from corresponding completed storyboards, and wherein machine learning algorithm is further trained on the plurality of final videos and the corresponding completed storyboards.

Aspects of the present disclosure relate to a method, wherein the final video includes at least a first portion of the plurality of scenes of a first complete storyboard of the plurality of storyboards and at least a second portion of the plurality of scenes of a second complete storyboard of the plurality of storyboards.

Aspects of the present disclosure relate to a method, wherein the final video includes a trimmed scene, wherein the trimmed scene includes a portion of a first scene of the plurality of scenes.

Additional aspects related to this disclosure are set forth, in part, in the description which follows, and, in part, will be obvious from the description, or may be learned by practice of this disclosure.

It is to be understood that both the forgoing and the following descriptions are exemplary and explanatory only and are not intended to limit the claimed disclosure or application thereof in any manner whatsoever.

### BRIEF DESCRIPTION OF THE DRAWING

The incorporated drawings, which are incorporated in and constitute a part of this specification exemplify the aspects of the present disclosure and, together with the description, explain and illustrate principles of this disclosure.

FIG. 1 is an illustrative block diagram of a system based on a computer configured to execute one or more aspects of the storyboard functionality described herein.

FIG. 2 is an illustration of a computing machine configured to execute one or more aspects of the storyboard functionality described herein.

FIG. 3 is a block diagram of an exemplary system for generating storyboards according to some embodiments of the present disclosure.

FIG. 4 is an exemplary flowchart for generating storyboards that can be performed in the embodiment of the system in FIG. 3.

FIG. 5 is an illustrative example of the admin making edits to the guardrails in the system of FIG. 3 according to some embodiments of the present disclosure.

FIG. 6 is an illustrative example of the storyboard generation module in the system of FIG. 3 according to some embodiments of the present disclosure.

FIG. 7 is an illustrative example of the user selecting the number of scenes in the system of FIG. 3 according to some embodiments of the present disclosure.

FIG. 8A is an illustrative example of the storyboard template in the system of FIG. 3 according to some embodiments of the present disclosure.

FIG. 8B is another illustrative example of the storyboard template in the system of FIG. 3 according to one or more embodiments of the present disclosure.

FIG. 9 is an illustrative example of the one or more shots, overlays, and/or voiceover of the scenes in the system of FIG. 3 according to some embodiments of the present disclosure.

FIG. 10 is an illustrative example wherein data is extracted externally to automatically generate a storyboard according to some embodiments of the present disclosure.

FIG. 11 is an illustrative example wherein data is extracted externally to automatically generate a storyboard according to some embodiments of the present disclosure.

FIG. 12 is an illustrative example wherein data is extracted externally to automatically generate a storyboard according to some embodiments of the present disclosure.

FIG. 13 is an exemplary flowchart for creating user-generated content that can be performed in the embodiment of the system in FIG. 3.

FIG. 14 is an exemplary flowchart for managing user-generated content that can be performed in the embodiment of the system in FIG. 3.

FIG. 15 is an illustrative example of a customized video template with a built-in prompt according to some embodiments of the present disclosure.

FIG. 16A is an illustrative example of guide rails within the customized video template according to some embodiments of the present disclosure.

FIG. 16B is an illustrative example of guide rails within the customized video template according to some embodiments of the present disclosure.

FIG. 17 is an illustrative example of user metrics within the content management system according to some embodiments of the present disclosure.

FIG. 18 is an illustrative example of user-generated video archive within the content management system according to some embodiments of the present disclosure.

FIG. 19 is an illustrative example of an ecommerce interface according to some embodiments of the present disclosure.

FIG. 20 is an illustrative example of an ecommerce interface according to some embodiments of the present disclosure.

FIG. 21 is an illustrative example of an ecommerce interface according to some embodiments of the present disclosure.

FIG. 22 is an illustrative example of an ecommerce interface according to some embodiments of the present disclosure.

FIG. 23 is an illustrative example of an ecommerce interface according to some embodiments of the present disclosure.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

Businesses and consumers have limited options to create high quality, branded video content aligning with their brand preferences. Businesses and consumers want to create video content, but don't know how to start. Businesses and consumers open Instagram, TikTok and other popular free apps to a blank canvas with little to no guidance on how to create a video. This leads to creation paralysis and a majority of people never end up creating a video on their own. For large enterprises, there is often a lack of quality control, brand consistency, and volume of video output when their employees or contractors are used to create the video content. The advantage of using a storyboard is to guide businesses and consumers through the process of capturing high quality, branded and fully edited video content with the intention of generating a video that will help them convey a message aligning with their predefined brand preferences. Such brand preferences may already be established, or the brand may have a strong desire to establish preferences. Premade storyboard templates may ensure that user-generated content aligns with their brand preferences by guiding users to create content in a way preferred by the brand.

Throughout the present disclosure, reference will be made to “a brand” or “the brand.” It should be noted that the use of “the brand” in the context of control or other activities undertaken by legal entities is used to refer to the entity owning the product or service or in charge of marketing the product or service that is the subject of the storyboards and other videos described below. The brand may be considered the entity exercising control of the product or service being featured in storyboards. The users creating user-generated content are individuals who have used the products or services or employees of the brand that are knowledgeable of the products or services. Together, the brand and the various users form a network, and it is this network that creates final videos based on user-generated content that aligns with the brand's preferences.

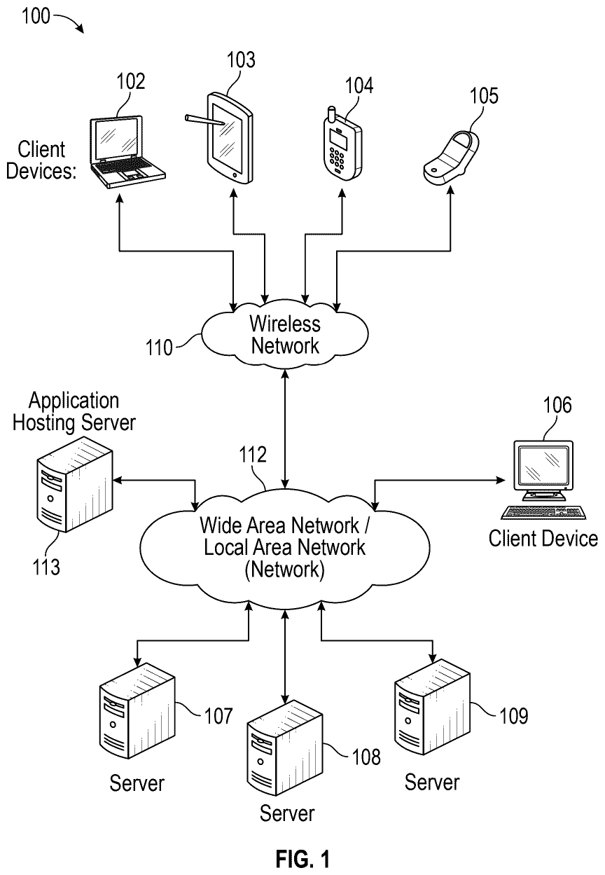

FIG. 1 illustrates components of one embodiment of an environment in which the disclosure may be practiced. Not all of the components may be required to practice the disclosure, and variations in the arrangement and type of the components may be made without departing from the spirit or scope of the disclosure. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. Various of the client devices 102-106 may include, for example, desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

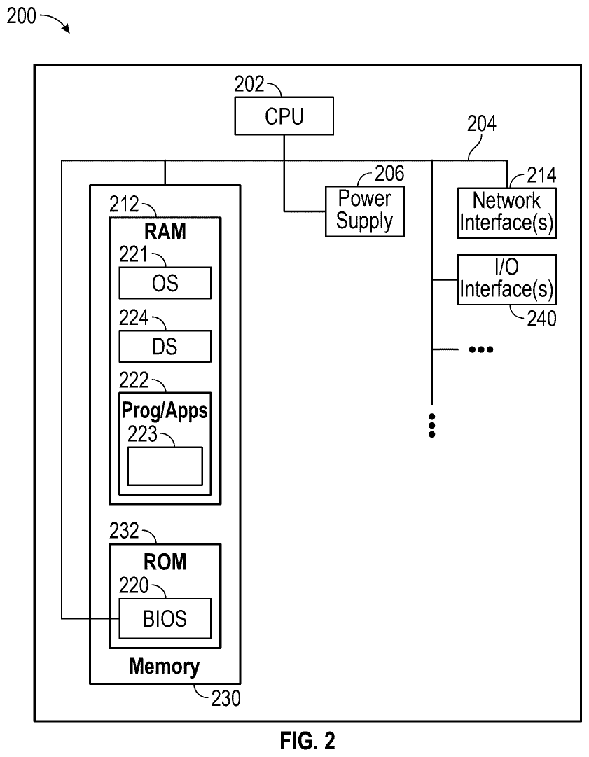

FIG. 2 illustrates a block diagram of an electronic device 200 that can implement one or more aspects of an apparatus, system, and method for generating a storyboard for users (the “storyboard generation module”) according to one embodiment of the disclosure. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, database 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the disclosure. The elements may exist on a single computer or be distributed among multiple computers, servers, devices or entities.

The power supply 206 contains one or more power components and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can case processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the storyboard generation module, via a network to another device. Also, an application server may, for example, host a web site that can provide a user interface for administration of example aspects of the storyboard generation module. In addition, the server is communicably coupled to various platform application programming interfaces (APIs).

One or more features or steps of the disclosed embodiments may be implemented by an API. An API may define one or more parameters that are passed between a calling application and other software code (e.g., an operating system, library routine, function) that provides a service, that provides data, or that performs an operation or a computation.

The API may be implemented as one or more calls in program code that sends or receives one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some embodiments, an API call may report to an application the capabilities of a device running the application, such as input capacity, output capacity, processing capability, power capability, communications capabilities, etc.

Any computing device capable of sending, receiving, and processing data over a wired and/or a wireless network may act as a server, such as in facilitating aspects of implementations of the storyboard generation module. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass database, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system, and method of the storyboard generation module. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system, and method embodying the storyboard generation module. Content may include, for example, text, images, audio, video, and the like.

In example aspects of the apparatus, system, and method embodying the storyboard generation module, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system, and method embodying the storyboard generation module, may range widely in terms of capabilities and features. For example, a cell phone, a smart phone, or a tablet may have a numeric keypad and a few lines of monochrome Liquid-Crystal Display (LCD) display on which only text may be displayed. In another example, a Web-enabled client device may have a physical or virtual keyboard, database (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system, and method implementing the storyboard generation module, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search storyboard generation module, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system, and method implementing the storyboard generation module, one or more networks, such as networks 110 or 112, for example, may couple servers and client devices with other computing devices, including through wireless network to client devices. A network may be enabled to employ any form of computer readable media for communicating information from one electronic device to another. In such an embodiment, the operation may be carried out on a singular device or between multiple devices (e.g., a server and a client device). A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system, and method implementing the storyboard generation module, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G), 5^{th} (5G) generation, Long Term Evolution (LTE) radio access for cellular systems, WLAN, Wireless Router (WR) mesh, and the like. Access technologies such as 2G, 2.5G, 3G, 4G, 5G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system, and method implementing the storyboard generation module, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present disclosure include apparatuses, systems, and methods implementing the storyboard generation module. Embodiments of the present disclosure may be implemented on one or more of client devices 102-106, which are communicatively coupled to servers including servers 107-109. Moreover, client devices 102-106 may be communicatively (wirelessly or wired) coupled to one another. In particular, software aspects of the storyboard generation module may be implemented in the program 223. The program 223 may be implemented on one or more client devices 102-106, one or more servers 107-109, and 113, or a combination of one or more client devices 102-106, and one or more servers 107-109 and 113.

As noted above, embodiments of the present disclosure may relate to apparatuses, methods, and systems for storyboard generation and evaluation of data thereof. The embodiments may be referred to simply as the system 300.

The system 300 may utilize the computerized and network elements as described above and as illustrated in FIGS. 1-2. Accordingly, the system may include hardware and software elements (as embodied in system 100 and electronic device 200) configured to execute the features of the algorithms and workflows described herein.

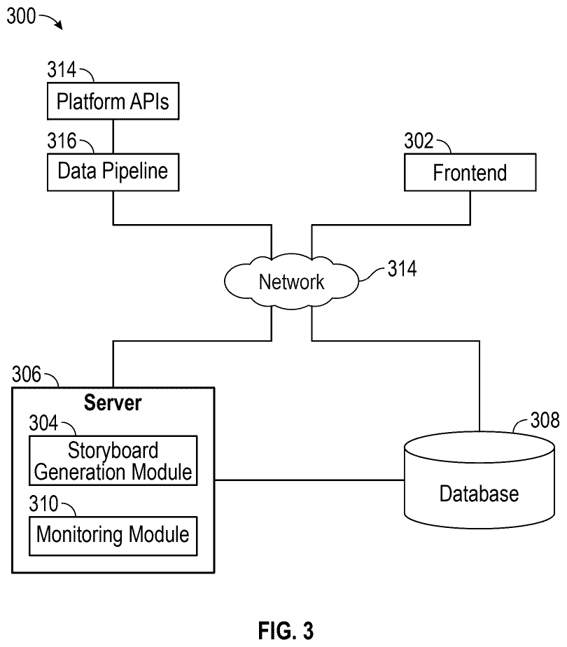

The system 300 may include an architecture comprising a plurality of modules, servers, and/or computing devices, each configured to implement one or more actions associated with the overall storyboard generation workflow. FIG. 3 illustrates an embodiment of the system 300. The frontend 302 may employ one or more elements of the system 300, wherein said frontend 302 may be executed on an electronic device 200 (i.e., a smart phone, a mobile device, or computer). As a nonlimiting example, the frontend 302 may be comprised of a plurality of hardware components within a user's smart device. In such a nonlimiting example, the frontend 302 may receive input from the user and/or deliver output to the user.

In an embodiment, the system 300 may include a storyboard generation module 304. As a non-limiting example, the storyboard generation module 304 may be utilized by businesses, influencers, content creators, or other suitable parties. In such instances, the storyboard generation module 304 may be configured to receive data, via one or more APIs, from various digital platforms, process said data, and output a corresponding storyboard template.

The storyboard generation module 304 may include or may be in informatic communication with an Artificial Intelligence (AI) component. In some embodiments, the AI component may be configured to include various models trained on vast corpuses of training datasets utilizing a targeted schema (e.g., training a realtor-centric model on real estate listing video content).

The storyboard generation module 304 and the system 300, may be accessible via a web-based application (e.g., accessible via a web browser), a mobile application (e.g., an “app” executable on a mobile operating system), and/or another platform. For example, the storyboard generation module 304 may be displayed on a desktop computer, tablet, mobile device, wearable, smart device, or other computerized apparatus.

The frontend 302 may include an accelerometer which may be utilized to perceive undesirable movement or vibration that could interfere with video capture. As a nonlimiting example, the accelerometer may be adapted to measure the change or fluctuation in acceleration during the course of moving the frontend 302. Accordingly, in an instance where smooth or steady pan motion of the frontend 302 is desired, acceleration (as calculated via sensed data from the accelerometer) should be present at the beginning and end of the panning motion when the frontend 302 accelerates and decelerates, respectively. Otherwise, the acceleration should be minimal during constant motion of the steady pan. In such an instance, if the acceleration changes by a given threshold acceleration (or speed) value, the system 300 may determine that the pan was not of desirable quality. In an embodiment, such a determination or threshold crossing may cause the frontend 302 to generate a corrective prompt warning the user to stabilize the pace of frontend 302 movement during the pan. In another embodiment, such a determination or threshold crossing may cause the video capture to cease or pause, enabling the frontend 302 (and indirectly, the user) to restart the capture. Moreover, the accelerometer threshold may not be a singular value (e.g., a static differential in acceleration that would render the captured video undesirable), but instead modeled to a desired “pace” of a shot. For example, in an instance where a shot requires the point of capture to increase or decrease speed or acceleration during the course of the shot, the threshold may be the modeled acceleration or speed curve (or allowable deviations thereof). In such an example, the corrective prompts may be generated when the frontend 302 is not accelerating at the desired pace as dictated by the modeled acceleration or speed curve. In an embodiment, the accelerometer may be utilized to determine whether the frontend 302 is tilting or rotating. As a nonlimiting example, the system 300 may generate directive prompts for shots that require tilting or rotating of the frontend.

In an embodiment, the gyroscope, unlike the accelerometer, which may be configured for linear acceleration detection, may be configured to measure the angular velocity or rotational movement about the frontend 302. However, the gyroscope data and the accelerometer data may be leveraged or fused to provide real time feedback to the frontend 302, for example, via real time corrective prompt display. The gyroscope or data thereof may be utilized to determine whether the frontend 302 is of a desired stability during a given shot capture. Accordingly, if the frontend 302 is determined to move in any of the three axes (pitch: tilt forward and backward; roll: tilt side to side; and yaw: rotation left or right) beyond a given threshold, wherein there may be a subthreshold for each of the three axes, a corrective prompt may be generated and displayed. For example, the corrective prompt may inform the frontend user to slow or steady rotation of the frontend 302 or to stop inadvertently tilting the frontend 302 forward or backward during capture.

In an embodiment, the system 300 may detect undesirable movement during video recording by assessing volume decibel/sound levels measured via the frontend's microphone. Such an assessment may include monitoring the intensity of perceived sound levels, detecting and analyzing variations in decibel levels to identify a motion-related sound level (e.g., frontend handling noises or environmental noises), and curating corrective prompt feedback to the frontend 302 when unwarranted movement is detected. In one embodiment, the frontend's microphone may be configured to continuously measure decibel levels while the frontend 302 is capturing a video or photograph.

The frontend's microphone may be adapted to detect sounds resulting from the frontend's movement, including vibrations or shifting of the frontend 302. The frontend 302 may be configured to detect, for example, high pitch noises caused by vibration of the frontend 302. In another embodiment, the system 300 is configured to detect repetitive patterns in noises. The system 300 may be configured to generate warnings or corrective prompts based on the analyzed audio data, for example, instructing the user to “slow down” or “shield the device from wind.”

In an embodiment, the frontend's microphone is utilized to determine whether the audio being captured by the frontend 302 is of suitable quality and/or whether there is undesirable background or environmental noise exceeding an ambient noise level or a sound level threshold. As described herein, the system 300 may be configured to capture audio and/or video from the frontend 302. In instances where a verbal dialogue or other audio signature is desired for capture, the frontend microphone's readings may be used to determine whether intervening noises exceed a given threshold sound level or ambient noise level. Such a threshold sound level is set to prevent said intervening noises from rendering verbal dialogue inaudible or otherwise hard to hear. Accordingly, the frontend 302 may display corrective prompt(s) when such a threshold is surpassed.

In an embodiment, the frontend 302 includes one or more light sensors (e.g., ambient light sensors) capable of detecting a light level of the environment where the content capturing is taking place. If the aforementioned light sensor detects inadequate or excessive light levels, the frontend 302 may display a corrective prompt as such.

In addition to the tailored corrective prompts discussed above, the system 300 may utilize the aforementioned components (e.g., accelerometer, gyroscope, microphone, light sensor) and related components to automatically actuate video stabilization features or other real-time corrective features. As a nonlimiting example, such features may include stabilizing algorithms, wherein the system 300 utilizes such algorithms to “clean” the captured footage. Such algorithms or software features may, in post-production or during capture, stabilize the captured video.

In an embodiment, each scene may include corresponding acceptable parameters and/or thresholds. For example, each scene may include acceptable fluctuations, frequencies, changes, thresholds, profiles, curves, and/or absolute or relativistic values for each of the characteristics described above (e.g., frontend linear movement, tilt/roll/yaw, perceived decibels, incident light, etc.). In one instance, a given scene may require a very well-lit shot of strictly steady movement. In such an instance, the scene may be tagged with a high light requirement and a low acceptable threshold of acceleration fluctuation. Accordingly, the various frontend components may all be utilized for a scene, but may be, in effect, weighted as a function of the desired scene parameters. For example, in a scene where verbal audio is a significant component, the threshold for ambient noise may be set low, such that minor intervening noises trigger a corrective prompt.

The frontend 302 may be in communication with a storyboard generation module 304. The storyboard generation module 304 may generate a storyboard. For the present disclosure, a “storyboard” is an outlined sequence of scenes representing the shots planned for a video. A “storyboard” may comprise a sequence of frames or panels that represent key scenes or moments in a narrative. Each frame may include elements such as objects, subjects, settings, and actions, providing a visual blueprint for the storyteller. Through the arrangement of these elements, storyboards may convey the flow and pacing of a narrative, serving as a tool in the production process to ensure an effective storytelling experience. For the purposes of the present disclosure, a “scene” can include one or more video clips. In an embodiment, a “storyboard template” may be a series of empty audiovisual receptacles (e.g., in a time series editable video format), wherein each empty audiovisual receptacle is governed by a scene and the scene's corresponding desirable characteristics. In such an embodiment, the empty audiovisual receptables may be configured to be filled with a video file, wherein the video file is the result of a capture via the frontend 302, wherein the frontend 302 delivers corrective and/or directive prompts to assist the capturer in capturing video in accordance with the underlying's scene's desired characteristics (e.g., high light, quick zoom, slow pan, wide shot, a given audio characteristic, etc.).

The storyboard generation module 304 may be communicably coupled to a server 306. The server 306 may be further communicably coupled via a network 312 to a data pipeline 316 adapted to interface with various platform APIs 314. Examples of platforms providing platform APIs 314 may include, but are not limited to Expedia, Amazon, Hello Fresh, Multiple Listing Service (MLS), and the like. Said APIs 314 may enable access to user data and/or content on the platform. Examples of content can include travel itineraries, property data, product descriptions, and the like, that is associated with the user or a mutually relevant object (e.g., real property, which may have property information stored in MLS) on the platforms. The platform APIs 314 may enable access to the content on said platforms.

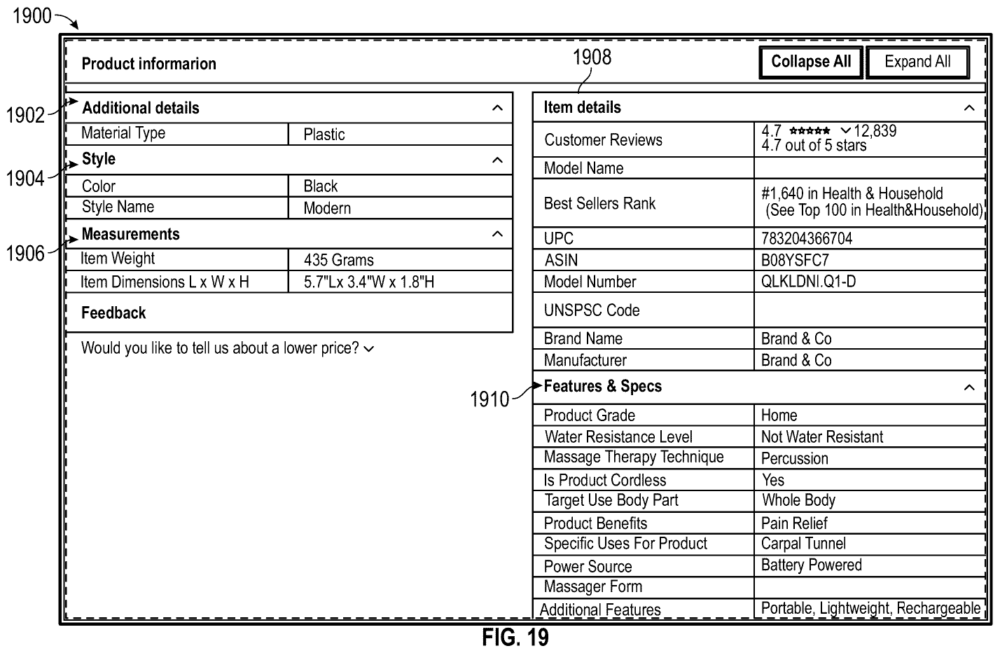

Reference will now be made to an example ecommerce interface (as shown in FIGS. 19-23), wherein the underlying product information is retrievable via one or more APIs 314. FIG. 19 shows an ecommerce interface 1900 with information retrievable via an API 314 for an ecommerce listing for an office chair. The server may be capable of scraping the additional details 1902 such as material type, the style 1904 of the product, the measurements 1906 of the product, the item details 1908, and the features and specifications 1910 from the ecommerce interface 1900. For the purposes of this disclosure the product data (e.g., titles, images, key features [those shown in bulleted form on the interface], product descriptions, technical details, and/or variations and attributes) may be retrieved via an API 314 (e.g., an ecommerce product advertising API) and/or via web scraping (e.g., retrieving data from publicly visible parts of a product listing page). The system 300 may be configured to utilize API-fueled data retrieval first and, if the API-fueled data retrieval is unsuccessful, then the system 300 may utilize a web scraping mechanic.

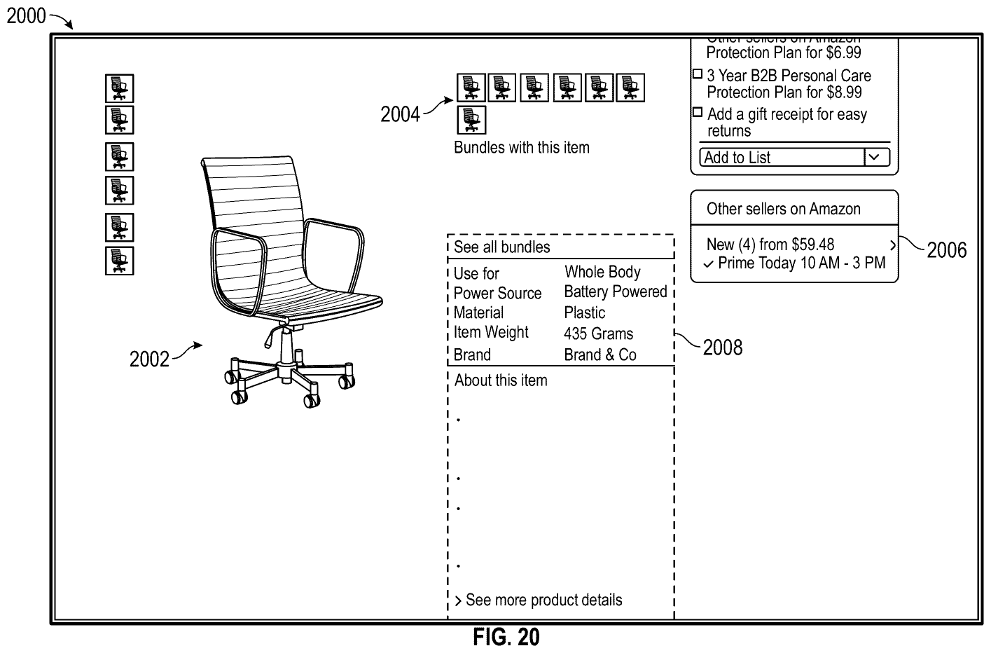

FIG. 20 shows an ecommerce interface 2000 with underlying product information retrievable via one or more APIs 314 for an ecommerce listing for an office chair. The server may be capable of scraping the product image 2002, alternative thumbnail images 2004, a product price 2006, and other information 2008 from the ecommerce interface 2000.

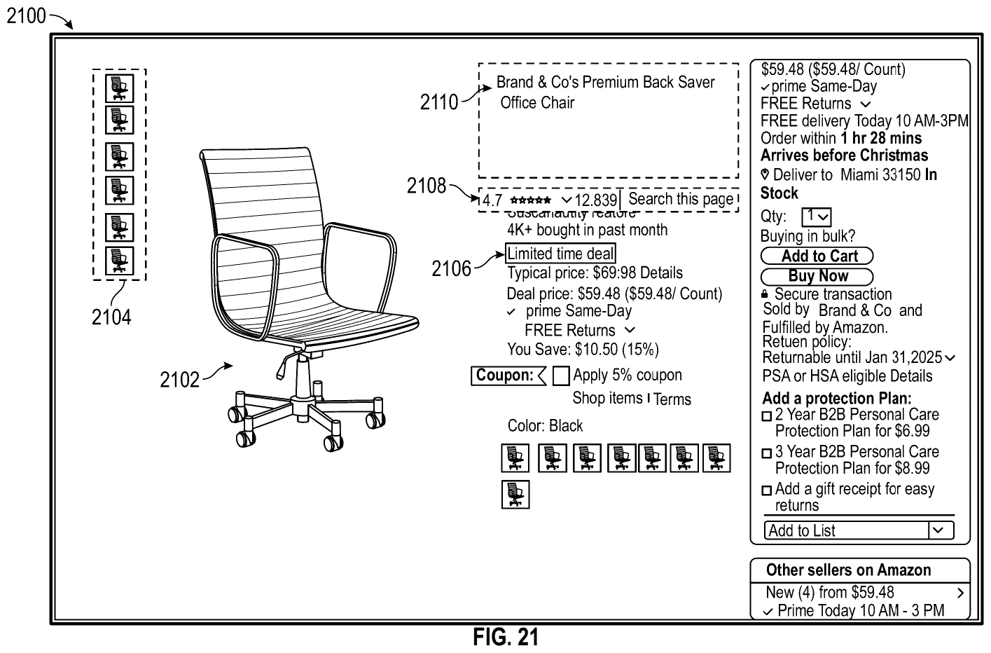

FIG. 21 shows an ecommerce interface 2100 with underlying product information retrievable via one or more APIs 314 for an ecommerce listing for an office chair. The server may be capable of scraping the product image 2102, alternative thumbnail images 2104, the details of a limited time deal 2106, the product ratings 2108, and the product title 2110 from the ecommerce interface 2100.

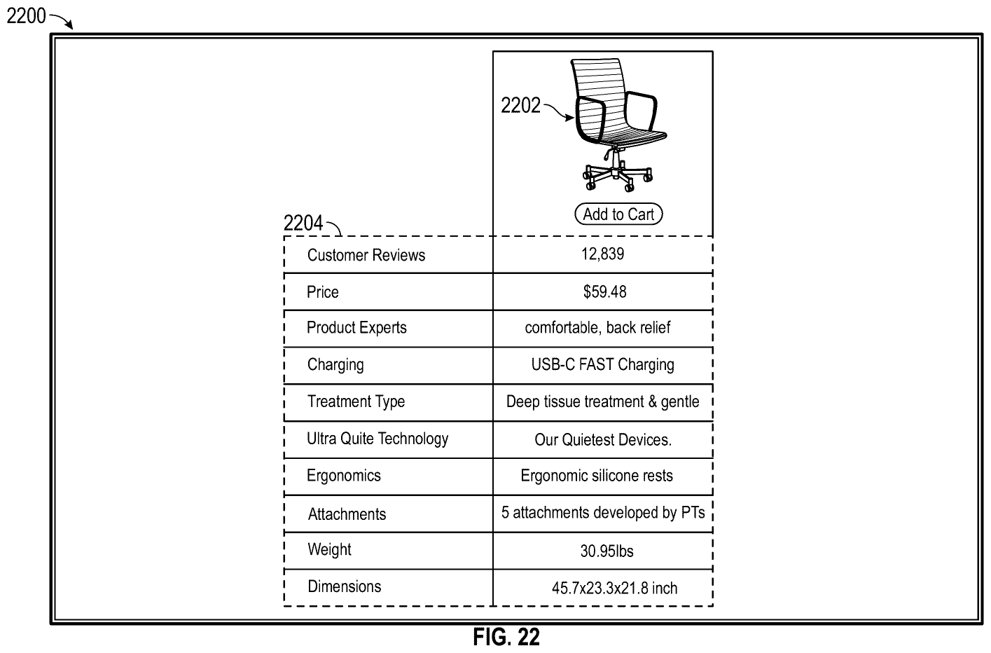

FIG. 22 shows an ecommerce interface 2200 with underlying product information retrievable via one or more APIs 314 for an ecommerce listing for an office chair. The server may be capable of scraping the product image 2202 and the additional information 2204 from the ecommerce interface 2200.

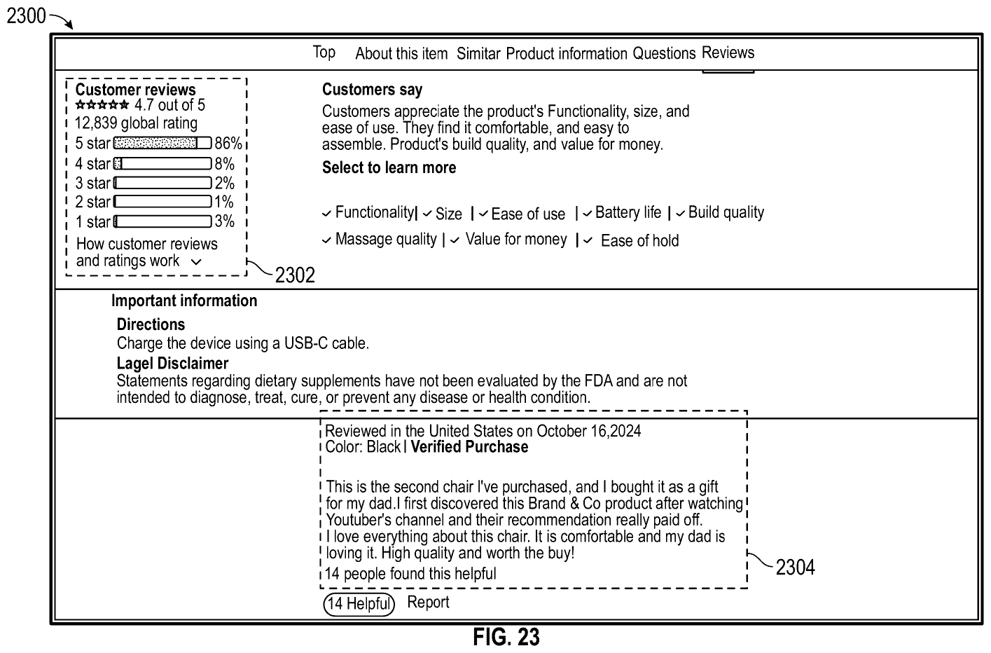

FIG. 23 shows an ecommerce interface 2300 with underlying product information retrievable via one or more APIs 314 for an ecommerce listing for an office chair. The server may be capable of scraping the detailed customer reviews 2302 and any posted reviews 2304 from the ecommerce interface 2300.

In some embodiments, the server 306 may monitor a platform (e.g., ecommerce platforms, online real estate marketplaces, and the like) via an API to detect any content from the platform and input the content into the storyboard generation module 304. The storyboard generation module 304 may be configured to determine the content type by identifying the platform the content originates from. For example, the storyboard generation module 304 may be configured to determine that the “content type” for content from an ecommerce platform is a “product”. The content type may be a category the content falls within, for example, the content type may be a “real estate property” in an instance where the content is a residential home listing on an online real estate marketplace. For the purposes of this disclosure, the content may include content data, such as text or images related to the underlying properties of the content. In some embodiments, the content type may determine what content data the storyboard generation module 304 may extract from the content. The storyboard generation module 304 may be adapted to extract content data from the content dependent upon the categorized content type. As a nonlimiting example, if the content type is a “product,” the storyboard generation module 304 may extract the Universal Product Code, price, and stock quantity (collectively, the “content data”) from the content.

In some embodiments, the server 306 may generate a storyboard template through the storyboard generation module 304 by evaluating at least one of content data and content type. In another embodiment, the server 306 may generate a storyboard template through the storyboard generation module 304 via transmission of a pre-built storyboard template from the database 308 to the storyboard generation module 304. In some embodiments, the platforms (e.g., ecommerce platforms, online real estate marketplaces, and the like) may upload their own pre-built storyboard templates to the database 308. The database 308 may store at least one of the pre-built storyboard templates, the platform pre-built storyboard templates, and the user's previously made storyboard templates. For the purposes of this disclosure, the database 308 may embody one or more, or all of the databases and data stores described herein. Accordingly, references to the database 308 may be interpreted to include any of the other databases described herein and, vice versa, any of the other databases described herein may be interpreted to include the database 308.

The storyboard generation module 304 may be configured to analyze said templates in the database 308 to iteratively learn to extract the content type and/or key features (e.g., size, color, quantity, or variant) of the content data for the templates. In some embodiments, the storyboard generation module 304 may compare the content type of the content with the content types from the templates in the database 308 to determine which templates in the database have a similar content type. In effect, such a mechanism may be utilized to determine an existing storyboard template that would best suit, is most related to an incoming content, or would provide a basis for a new (yet related) storyboard template. Further, the storyboard generation module 304 may compare the key features of the content to the key features of the templates to determine what scenes are to be added to the storyboard template for each key feature. As a nonlimiting example, the storyboard generation module 304 may compare the key features of the content to the key features of the templates using a machine learning technique (e.g., natural language processing), wherein said comparison may analyze and/or identify similarities between the key features of the content and the templates.

In some embodiments, the storyboard generation module 304 may generate the storyboard template or a pre-built storyboard template and transmit it to the frontend 302, wherein the frontend 302 may provide a visualization of the storyboard template to the user. In one embodiment, if the storyboard generation module 304 constructs a storyboard template (for example, via a machine learning technique) with a high degree of similarity (for example, 80% or more of the same scenes) as a pre-built storyboard template, the storyboard generation module 304 may utilize the pre-built storyboard template instead of generating a new template. The user may interact with the generated storyboard template to add and edit scenes in the template to reflect a user's vision. The user may finalize the edits at the point where the storyboard generation module 304 generates a video storyboard. In such an embodiment, the story board generation module 304 may provide the storyboard template before finalization, allowing a user (for example, via the frontend 302) to adjust scenes and/or their directives, length, order, etc.

The storyboard generation module 304 may be initiated by a request initiated by a user operating the frontend 302 or by a request from a platform via the server 306. Accordingly, the storyboard generation module 304 may be adapted to detect one or more signals from the frontend 302. In some embodiments, the initial reception of the one or more signals from the frontend 302 to the storyboard generation module 304 may initiate the generation of the storyboard. In an alternative embodiment, the storyboard generation module 304 may be initiated upon the detection of relevant content from the server 306.

In various embodiments, the storyboard generation module 304 may exist within one or more client devices 102-106, one or more servers 107-109 and 113, and/or a combination of one or more client devices 102-106, and one or more servers 107-109 and 113. However, in another embodiment, the storyboard generation module 304 may be an external module or service in communication with the frontend 302, the server 306, and/or other components of the system 300 described herein.

The server 306 may be configured to execute actions. The actions may be initiated by the storyboard generation module 304 and may include storyboard generation. In an embodiment, the storyboard generation module 304 may be in communication with the database 308, such that actions performed by the storyboard generation module 304 may be informed by the storyboard templates within the database 308.

In some embodiments, the server 306 is configured to monitor one or more platforms associated with the user. The server 306 may identify and collect content from the monitored platforms, which may include booked trips and/or hotels, previously purchased goods and/or services, real estate information, travel itineraries, e-commerce platforms, real estate databases, automotive platforms, etc. In some embodiments, the server 306 may be configured to perform real-time monitoring.

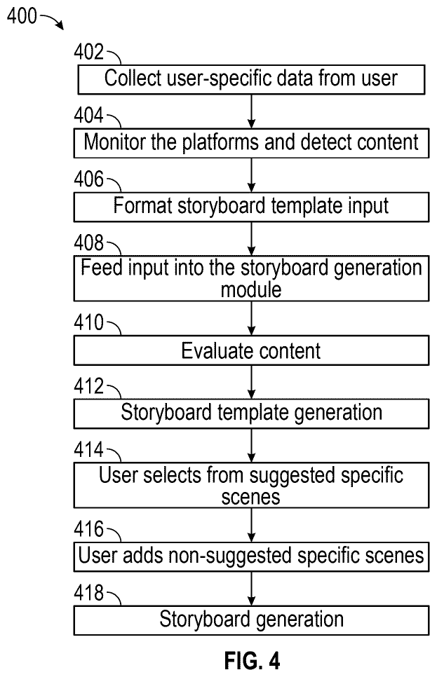

FIG. 4 is an example method 400 for automatically generating storyboards that can be performed within the system of FIG. 3 according to the embodiments of the present disclosure. In some embodiments, some or all of the method 400 may be performed by the server 306 and its various modules. However, in some embodiments, the steps of method 400 may be performed on the server 306 and/or the frontend 302.

For the purposes of this disclosure, “user-specific data” may refer to data retrievable from accounts associated with the user. “User-specific data” may include the user's employment information, social media information, and, notably, information pertaining to the to-be-generated storyboard. For example, “user-specific data” may include information extracted, pursuant to a user's request for a storyboard, wherein the user may input, via the frontend 302, that they are seeking a storyboard in advance of filming an advertisement for a used vehicle listing. Alternatively, the “user-specific data” may be automatically extracted and/or processed, wherein a user's digital items (e.g., videos, photos, etc.) may be analyzed to determine information necessary to initiate storyboard generation. Accordingly, the “user-specific data” (e.g., a VIN of a car) may be used later (e.g., “content” extraction) to determine “product-specific data” (e.g., description of the vehicle associated with the VIN, mileage, accident reports, etc.). Thus, as described herein, the “user-specific data” may be used to extract “content” (e.g., containing “product-specific data”), and said extracted “content” may be utilized to generate the storyboard. For the purposes of this disclosure, the “user-specific data” need not necessarily be derived from a “user.” For example, the “user-specific data” may be information derived from a product (e.g., automatically via extraction from a product platform) without intervention of a “user” or without direct extraction from said “user.” Thus, for the purposes of this disclosure the storyboard may be generated absent direct user intervention and may, instead, be generated based on a product listing, software element, document, or the like.

At step 402, the server 306 and/or another suitable component may identify and collect user-specific data from the user. For example, the system may be configured to determine the subject matter of the to-be-generated storyboard based on the user-specific data associated with said user. As a nonlimiting example, if the storyboard generation module 304 is configured to generate storyboards for various mediums, subject matters, and other parameters, at step 402, the system may determine the corpus of storyboards to be generated based on the user's field. Accordingly, the information extracted from the user (either manually or automatically via evaluation of the user's account information) may be utilized to narrow the prospective storyboard structure. As a further nonlimiting example, user-specific data may be the MLS identification number for a house the user intends to create a video advertisement for.

At step 404, the monitoring module 310 or another suitable component may monitor the platforms associated with the to-be-generated storyboard user. For the purposes of this disclosure, “content” may refer to the data retrievable from the platforms (e.g., MLS, Amazon, etc.) enabling automatic customization of the to-be-generated storyboard. As a nonlimiting example, the user may intend to create a video advertisement for a home listing. In such a nonlimiting example, the “content” may be the number of bedrooms, the acreage of the property, the estimated property taxes, and the like. Thus, the “user-specific data” may identify the particular product, property, or other specific entity, and the “content” may be characteristics associated with said particular product, property, or other specific entity. As described throughout this disclosure, analysis of the “content” enables accurate, efficient, and meaningful generation of storyboards. Accordingly, the storyboard may include specific scenes or shots to highlight elements derived from the “content.” As a nonlimiting example, the “user-specific data” may include an MLS identification number, wherein the “content” associated with the MLS identification number indicates that a house has both a marble staircase and a driveway overdue for repaving. In such a nonlimiting example, “content” may be evaluated to determine that the to-be-generated storyboard should include closeup shots of the staircase, to highlight its beautiful marble aesthetics, and wide shots of the front external of the house, to diminish the visibility of cracks in the driveway.

At step 406, the server 306 or another suitable component may format the content and/or user-specific data into an input readable for the storyboard generation module 304. Prior to the generation of storyboard templates, the content may be preprocessed, wherein user-specific data may allow for the storyboard generation module 304 to effectively generate the storyboard. Firstly, the content and/or user-specific data may undergo a cleaning process to rectify inconsistencies and eliminate inaccuracies, ensuring the integrity of the ensuing storyboard. Subsequently, a structured categorization of the content and/or user-specific data may facilitate the organization of information for coherent template generation. For example, information that is superfluous may be scrubbed during preprocessing. Further, missing and/or necessary information may be flagged and/or replaced (e.g., inserted with the likely value as determined by generative AI or another similar technique). Additionally, the normalization and standardization of data formats may be implemented. In another embodiment, an iterative validation process may be used to verify the accuracy of the preprocessed data, thus laying a robust foundation for the subsequent creation of meaningful and visually compelling storyboard templates.

At step 408, the server 306 or another suitable component may feed the preprocessed content and/or user-specific data as input to the storyboard generation module 304.

At step 410, the storyboard generation module 304 may be adapted to evaluate the content. In an embodiment, the storyboard generation module 304 may serve a wide variety of content. Moreover, the storyboard generation module 304 may first evaluate the content and/or the user-specific data to determine the corpus of relevant storyboard considerations for the respective field. For example, if the to-be-generated storyboard caters to video production for a family vacation video, the storyboard generation module 304 may direct the content to a submodule adapted for said application. In some embodiments, the content type indicates to the storyboard generation module 304 the relevant data and, conversely, the superfluous data from the preprocessed input. The evaluation determines the key features of the content data that will be included in or used to curate the storyboard template.

After evaluation of the content at step 410, at step 412, the storyboard generation module 304 may be adapted to create a storyboard template that can include one or more suggested specific scenes based on the key features of the content data. For example, if the user wants to make a video on a house that is listed by the user on MoxiWorks (or another suitable real estate platform or CRM), the server 306 inputs the content data of the house from MoxiWorks to the storyboard generation module 304, and the storyboard generation module 304 determines the key features by comparing the content from MoxiWorks with the anticipated key features. For example, the database 308 may include a list of key features represented in videos related to the subject matter of the user's request. Accordingly, such key features, in the context of self-promotion videos, may include descriptors of at least one of the video's subject, clientele likely to be interested in said subject, team meetings, landmarks near the region the subject represents, and the like. Therefore, the evaluation of content at step 410 permits the utilization of such content to determine key features and the storyboard elements to highlight the key features. For example, the storyboard generation module 304 may generate one or more suggested specific scenes based on the key features of the content data which may include, in a real estate context, the number of rooms, notable features of the house, the bedroom, the kitchen, and the like. In some embodiments, the generation of one or more suggested specific scenes may include one or more shots, overlays, and/or voiceovers within the one or more suggested specific scenes. The one or more shots, overlays, and/or voiceovers may be determined based on the features or aspects that should be highlighted. Said highlighted features may be determined based on similar content type pre-built storyboard templates, pre-built storyboard templates from the platform, previously made storyboard templates from the user, and the like.

In some embodiments, the generated storyboard template may include one or more suggested specific scenes based on the content type. For example, if the type of content is a trip itinerary, the generated storyboard template may include one or more suggested specific scenes of the user packing a suitcase, taking a mode of transportation, attending a tour, and the like. The one or more suggested specific scenes, including the one or more shots, overlays, and/or voiceovers, may be predetermined based on the content type.

In some embodiments, the one or more shots may include guardrail settings on how the one or more shots can be captured. The guardrail settings may include, but are not limited to, shot style, shot view, camera, prompt, suggested scene order, maximum recording length, and the like.

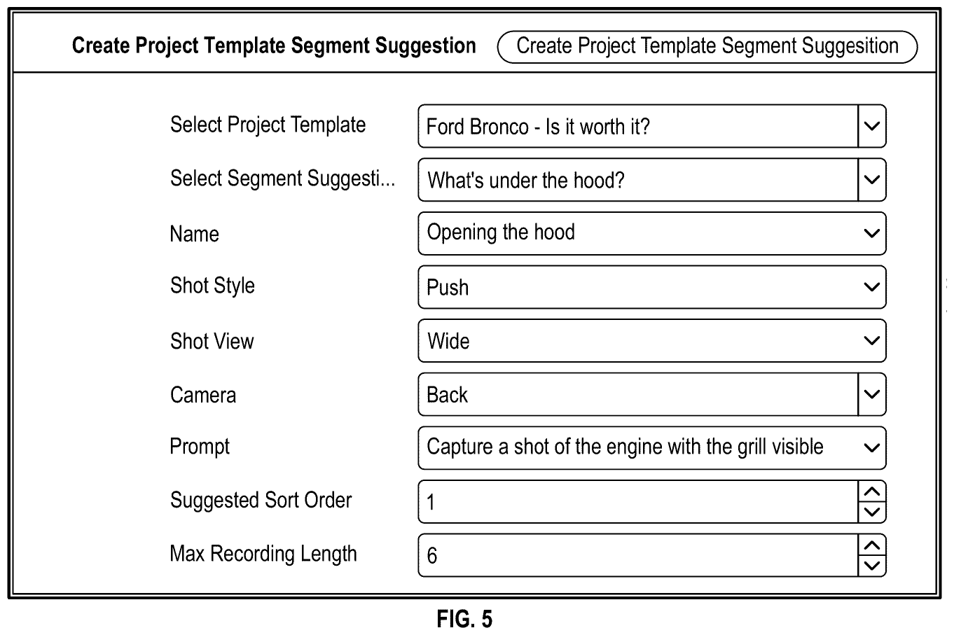

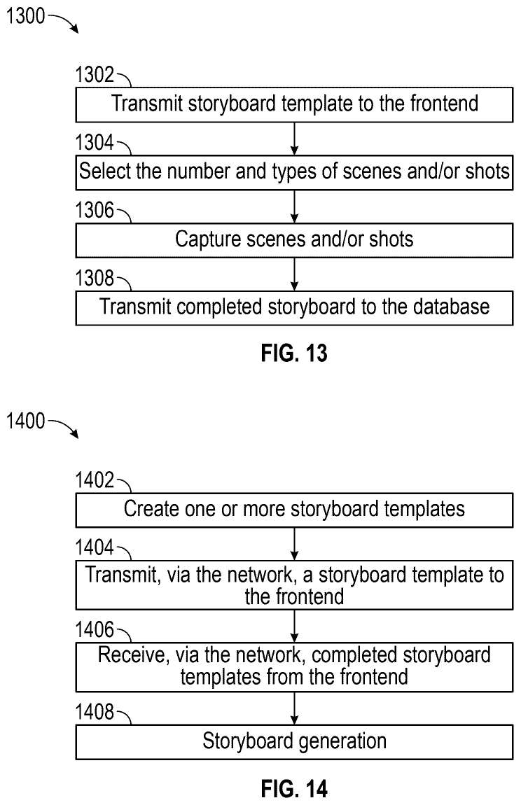

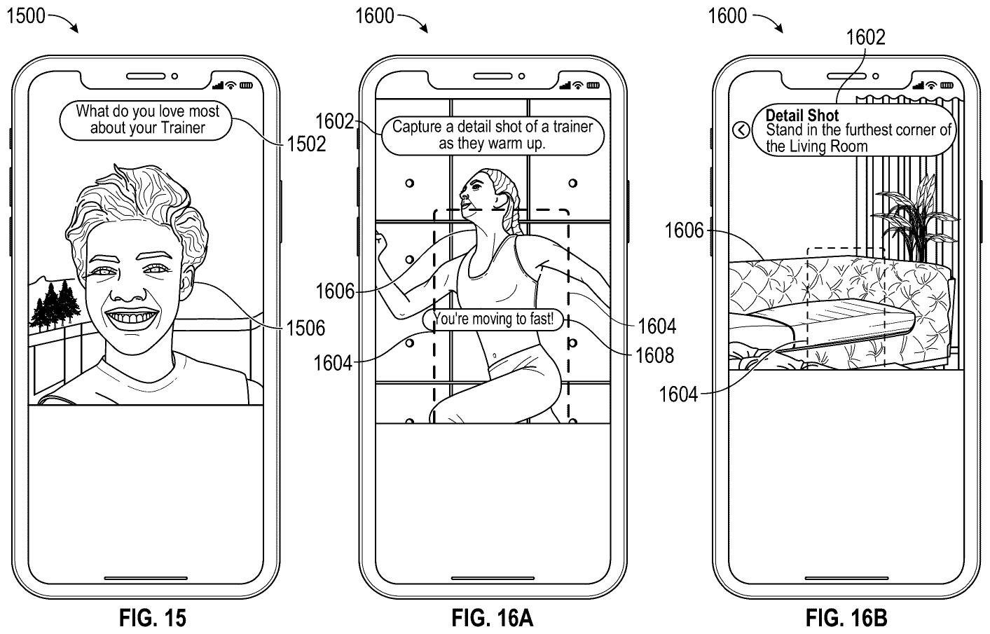

The guardrail settings may be based on the anticipated key features used for the generation of the one or more suggested specific scenes. In another embodiment, the guardrail settings may have default settings associated with a certain one or more suggested specific scenes. In some embodiments, an administrator and/or a user may edit the guardrail settings of the one or more suggested specific scenes of the pre-built storyboard template in the database 308. The storyboard generation module 304 may be adapted to generate guardrail settings based on said edits. The guardrail settings will be discussed in more detail herein with respect to FIGS. 5, 16A, and 16B.

At step 414, the user can select from the one or more suggested specific scenes. In some embodiments, the storyboard generation module 304 can allow the user, via a setup screen on the frontend 302, to modify the quantity or arrangement of the one or more suggested specific scenes. In alternate embodiments, the one or more suggested specific scenes may have a predetermined quantity and arrangement.

At step 416, the user can insert one or more non-suggested specific scenes that are not listed in the generated storyboard template. In some embodiments, the storyboard generation module 304 can allow the user, via a setup screen on the frontend 302, to modify the quantity or arrangement of the one or more non-suggested specific scenes. As a nonlimiting example, the system may be configured to receive one or more non-suggested specific scenes from the user, wherein the selection of said non-suggested specific scenes may be made via a drop-down menu or other interface permitting a user to select a desired scene type.

In some embodiments, the non-suggested specific scene may include a default shot, overlay, and/or voiceover. In addition, a default guardrail setting may be used for all non-suggested specific scenes. In alternate embodiments, the one or more shots, overlays, and voiceovers of the non-suggested specific scenes may be based on the one or more shots, overlays, and voiceovers of similar key features within prefilled templates in the database 308.

At step 418, the storyboard generation module 304 may generate a storyboard. In some embodiments, the storyboard may be editable for order of specific scenes, centerpiece object or purpose of capture, cinematographically relevant aspects of the scene, the quantity of clips for a given scene, and the like.

In one embodiment, the user may select, via the frontend 302, from pre-built storyboard templates from the database 308. For example, these storyboard templates can include, but are not limited to property tours, market updates, before and after, topic videos, pre-built storyboard templates from a platform, etc. In some embodiments, the pre-built storyboard templates can include one or more specific prompt sections that may include, but are not limited to, location, narratives, action, and the like. The specific prompt sections may each include one or more suggested scenes that can be added to the storyboard template. In some embodiments, the one or more suggested scenes may include one or more shots, overlays, and voiceovers, within the one or more suggested scenes. The one or more shots may include guardrail settings on how the one or more shots should be captured.

The storyboard generation module 304 may allow the user to insert one or more non-suggested scenes that are not listed in the specific prompt sections into the storyboard template. In some embodiments, the storyboard generation module 304 can allow the user to indicate the amount of the one or more non-suggested scenes. For instance, if the user selects a storyboard for a house tour for a house the user is trying to sell. The one or more suggested scenes can include a bedroom scene; however, there are multiple bedrooms. The user can indicate the amount of bedroom scenes to be the same as the number of bedrooms in the house. In some embodiments, the one or more non-suggested scenes may have a default one or more shots, overlays, and voice overs used for all non-suggested scenes. In addition, the one or more shots from the one or more non-suggested scenes may have default guardrail settings used for all non-suggested specific scenes. In alternative embodiments, the one or more shots, overlays, and voice overs of the non-suggested scenes may be based on the one or more shots, overlays, and voice overs of similar one or more suggested scenes in the database 308. In addition, the guardrail settings of the one or more shots in the similar one or more suggested scenes will be used with the one or more shots.

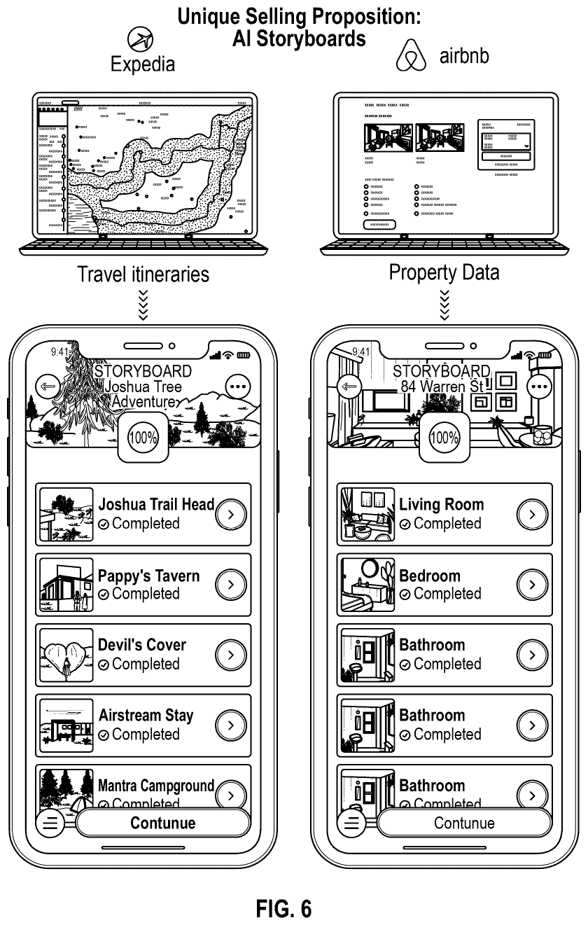

FIG. 6 is an illustrative example of the storyboard generation module in the system of FIG. 3. In some embodiments, the storyboard generation module 304 is configured to extract content from a third-party platform and evaluate the content thereof to automatically generate a storyboard based on a user's parameters.

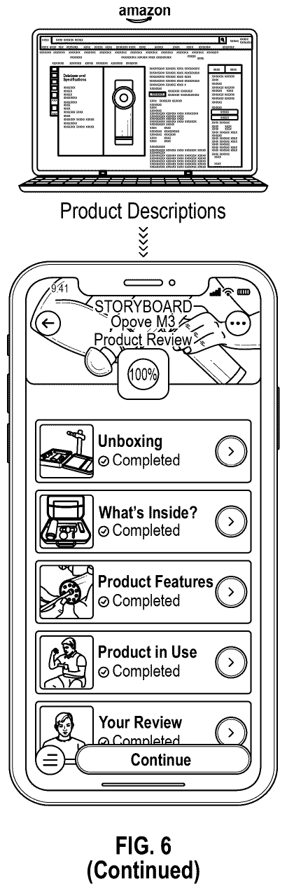

FIG. 7 is an illustrative example of a setup screen, wherein the user may manually select the number and types of scenes via the system infrastructure of FIG. 3. In some embodiments, the system may display a screen via the frontend 302 configured to enable selection of the quantity and type of one or more suggested specific scenes and/or one or more non-suggested scenes with the generated storyboard template. In addition, the users may indicate the number of scenes via any suitable interactive user interface feature (e.g., button, drop-down menu, slider, etc.).

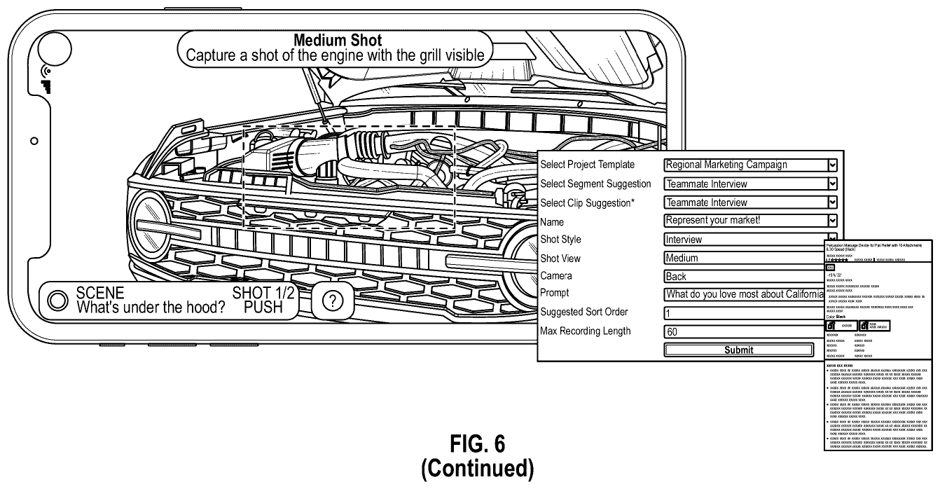

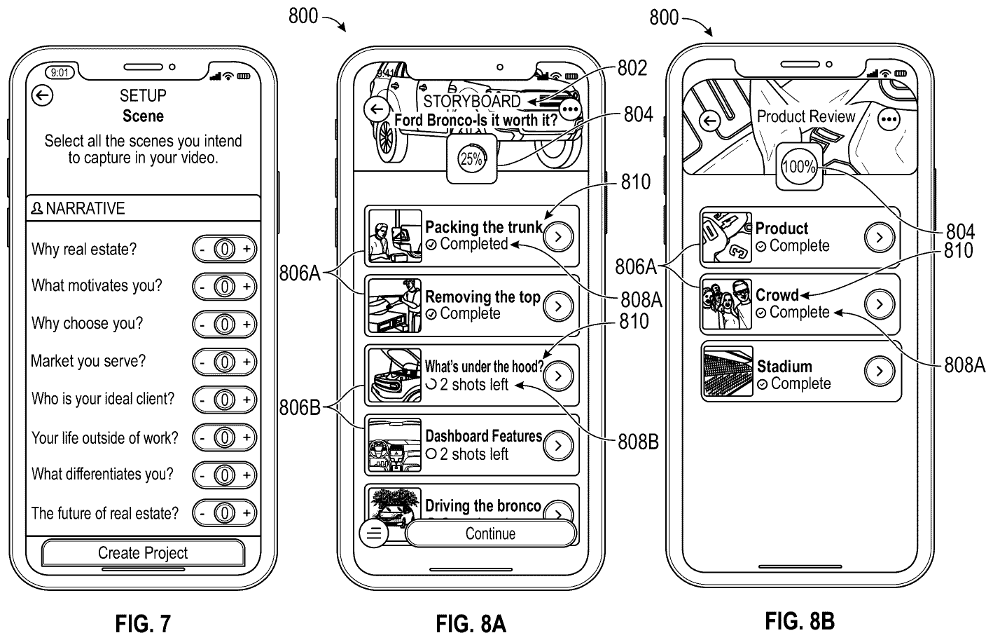

FIGS. 8A and 8B are an illustrative example of a storyboard template 800. The storyboard template 800 includes each of the scenes 806A, 806B of the storyboard 802 and a progress indication 808A, 808B as to the completeness of each scene. For example, each scene in the storyboard template may be accompanied by a meter showing how many of the recommended shots or clips have been captured or how many of the recommended shots or clips are left to be captured. Each of the scenes 806A, 806B may also have their own titles 810. The storyboard template 800 may also include a storyboard progress indication 804 which tells the user how many of the recommended scenes are completed or still need to be captured.

FIG. 5 is an illustrative example depicting an administrator or user making edits to the guardrails in the system of FIG. 3. In some embodiments, the administrator or user may interact with the guardrail settings of the pre-built storyboard templates in the database 308. The user generating the content is directed by the guardrail settings. The user follows the guardrail settings' instructions to generate content in line with the desires of the brand. Guardrail settings may vary for each scene 806A, 806B within a single storyboard template.

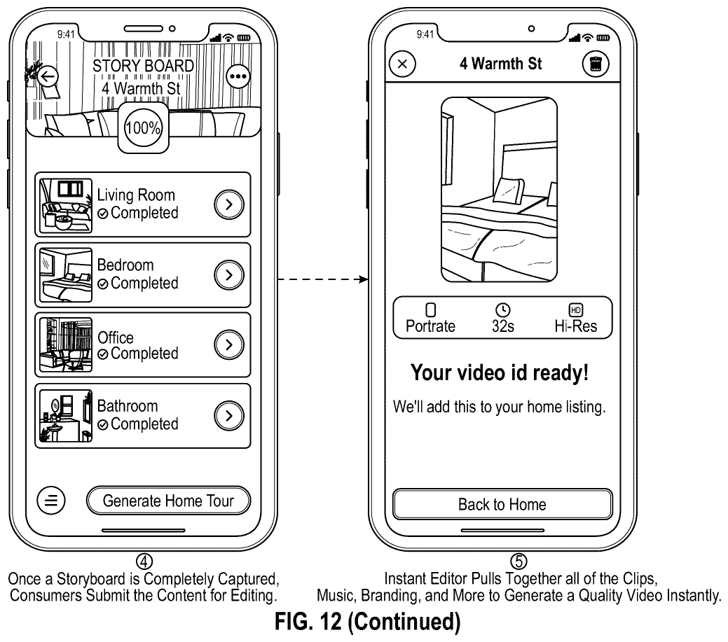

FIG. 15 is an illustrative example of the frontend 302 as a user is providing a testimonial 1500 in response to the directive prompt 1502. In the present illustration, the user is the subject 1506, and the user is giving their testimonial regarding a particular product. In other examples, users may provide testimonials for various products and services that brands may then use to spread awareness and reviews of their products and services. In some embodiments, the guardrail settings may include a scripted narrative. The scripted narrative may be displayed as a prompt on the front end screen or delivered through audible cues as the user is recording their testimonial. The scripted narrative may suggest or tell the user what to say in their testimonial.

FIGS. 16A and 16B are illustrative examples of the frontend 302 as a user is generating content 1600 of the subject 1606. While FIGS. 16A and 16B illustrate the subjects 1606 being a physical fitness trainer and a couch respectively, the subject may be any number of objects or activities that may be desirable. The subjects may include, but are not limited to, automobiles, automobile components, rooms, an artist, a game, or other products. Before and during capturing of the content 1600, each scene may include a directive prompt 1602 that provides general direction to the user generating the content. The directive prompt 1602 may inform the user of the desired content 1600 of the scene. For example, the directive prompt 1602 may state, “Capture a detail shot of a trainer as they warm up,” “Stand in the furthest corner of the living room,” or “center the engine block within the guardrails.” The aforementioned directive prompts are merely examples and are not intended to be limiting. The directive prompt 1602 may include any instructions the brand wishes to give to the user generating the content 1600.

As the user is capturing the content 1600, guardrails 1604 may be displayed on the frontend 302 in order to help the user keep the subject 1606 within the desired range of the shot. The system 300 may automatically detect whether the subject 1606 is not being properly captured within the content 1600. Upon such a detection, the system may provide the user with a corrective prompt 1608 to provide the user with real-time instructions to adjust the subject 1606 as the user is capturing the content 1600. A user generating content 1600 may see these corrective prompts and adjust how the content 1600 is being captured. For example, if the user is holding the camera in the wrong orientation, such as portrait versus landscape, or if the camera is registering an angled tilt, the corrective prompt 1608 may direct the user to rotate or tilt the camera to the correct position. Such a corrective prompt may also include visual instructions, such as directional arrows, indicating the specific direction the camera should be rotated/tilted. Corrective prompts 1608 may include, but are not limited to, “You're moving too fast,” “Hold the camera steady,” “Rotate/tilt the camera,” “Recenter the subject,” “The video is too dark,” and the like.

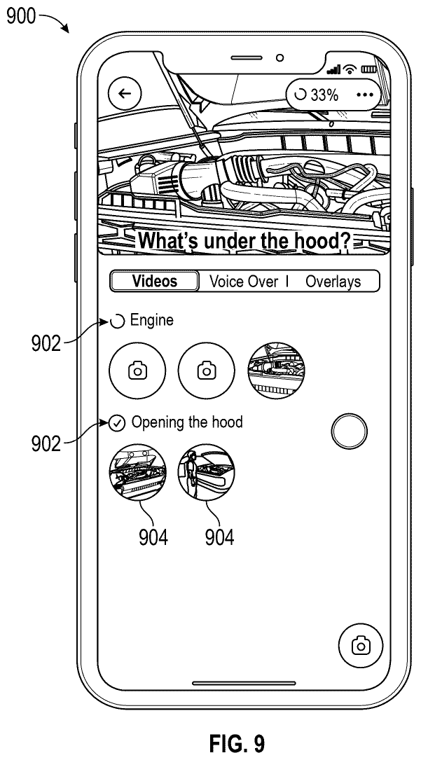

FIG. 9 is an illustrative example of an interface 900 within the storyboard generation workflow, wherein said interface displays the components 902 of a given scene. The interface 900 shown in FIG. 9 may display the various corresponding components 904 to a particular scene. As a nonlimiting example, and referring to FIG. 9, the scene may be “What's under the hood,” wherein the scene comprises required video portions, voice over portions, and/or overlay portions. As shown in FIG. 9, the video portions may be separated into various categories of clips (e.g., “engine” or “opening the hood”).

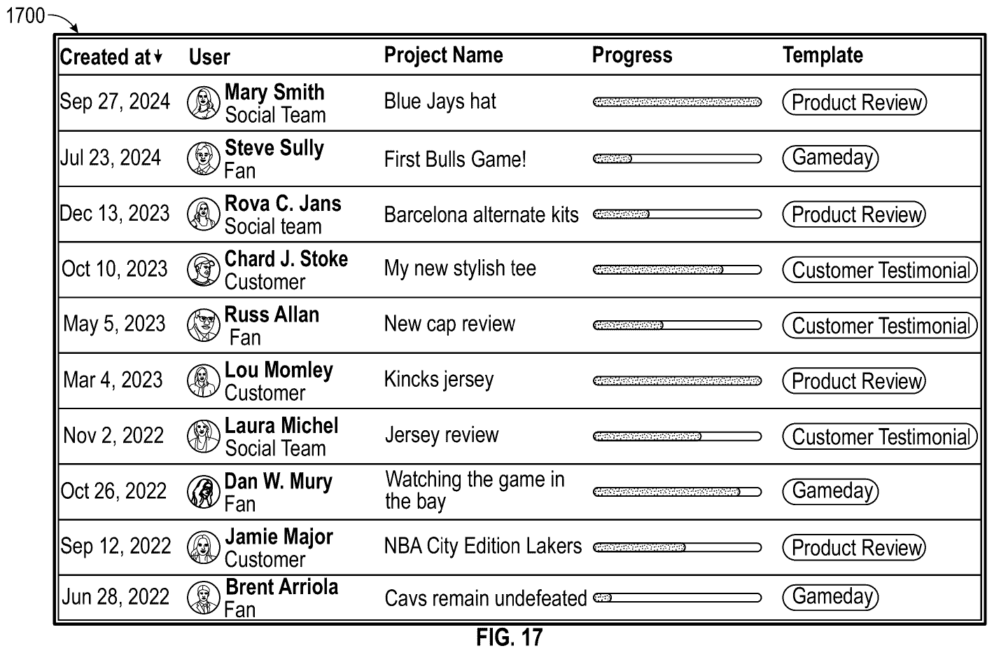

FIG. 17 is an illustrative example of a metric dashboard 1700 within the content management system. The metric dashboard 1700 allows a brand to review various metrics concerning the users and projects. The metrics may include information such as the date a user created or last edited a storyboard template, which user is creating the storyboard template, the project name associated with the storyboard template being edited by the user, the progress the user has made in editing/completing the storyboard template, and the title of the storyboard template being used. These metrics are merely examples and are not meant to be limiting in any way. The metrics may also include demographical information such as location or how long the user has been a part of the network. The brand may then organize the metric dashboard 1700 as they see fit. For example, the brand may wish to see what portion of user-generated content was created by new users versus veteran users.

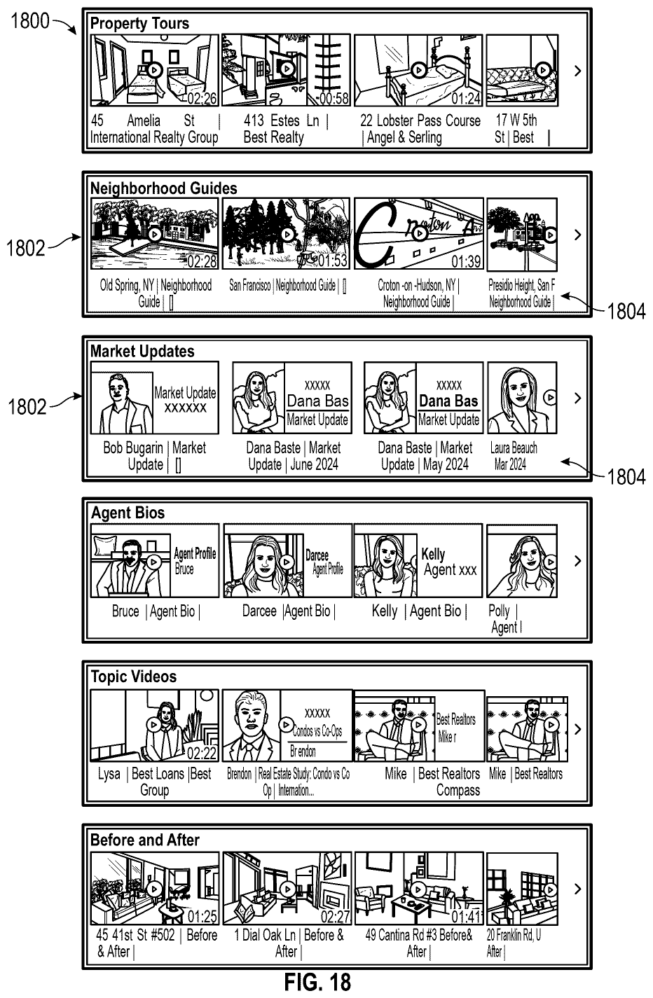

FIG. 18 is an illustrative example of an archive 1800 of user-generated content stored on the database within the content management system. From here, the brand may view the user-generated content to determine which videos and/or shots align with their image. The archive 1800 may include searching and filtering options in order to locate particular content or particular types of content. The archive 1800 may group the content into categories 1802 and display each video and/or shot with a descriptive title 1804.

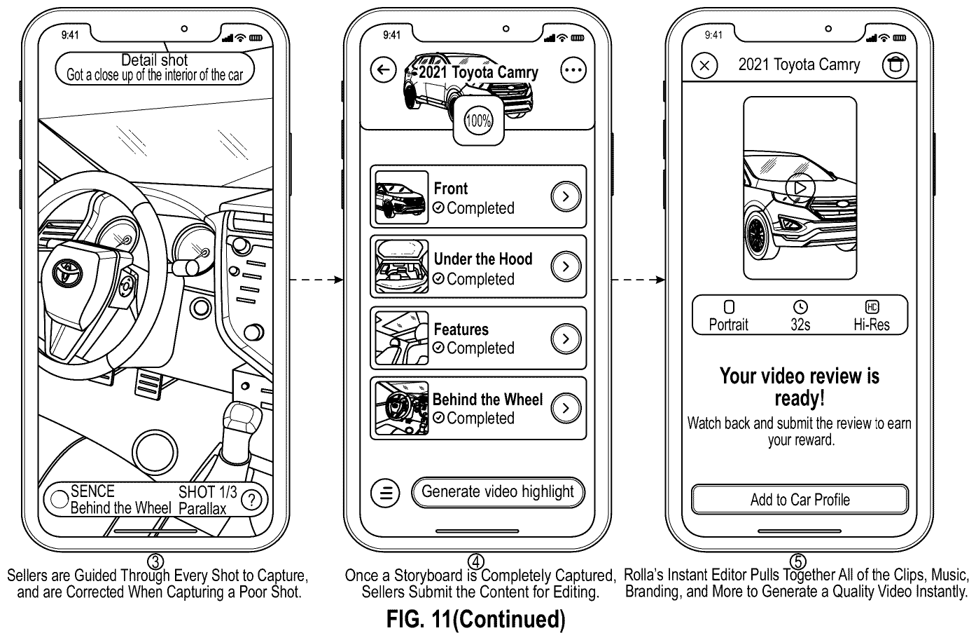

FIG. 13 is an example method 1300 for creating user generated content based on storyboard templates that can be performed within the system 300 of FIG. 3 according to the embodiments of the present disclosure. In some embodiments, some or all of the method 1300 can be performed by the server 306 and its various modules.

At step 1302, the server 306 and/or another suitable component may transmit, over a network 314, a storyboard template to the frontend 302 to be provided to the user. In some embodiments, the storyboard template may be one of several optional storyboard templates. In the same or other embodiments, the user may select the desired storyboard templates from the several options.

At step 1304, the user may select the number and types of scenes or shots through the frontend 302 via the system infrastructure of FIG. 3. The types of scenes or shots may be limited to the types of scenes or shots in the storyboard template provided by the brand, or the user may enter a custom type of scene or shot not included in the storyboard template.

At step 1306, the user may begin to capture photograph or video content based on the directive prompt(s) 1502, 1602 associated with a particular type of scene or shot. The user may then repeat step 1306 for each scene or shot until the storyboard template has been completed. The user may recognize the storyboard template as completed when the storyboard progress indication 804 communicates to the user that all scenes or shots have been completed or that there are no more scenes or shots left to be captured.

At step 1308, the system 300 may automatically transmit, from the frontend 302 to the database 308 via the network 314, the completed storyboard. In another embodiment, the user may manually submit the completed storyboard to the database.

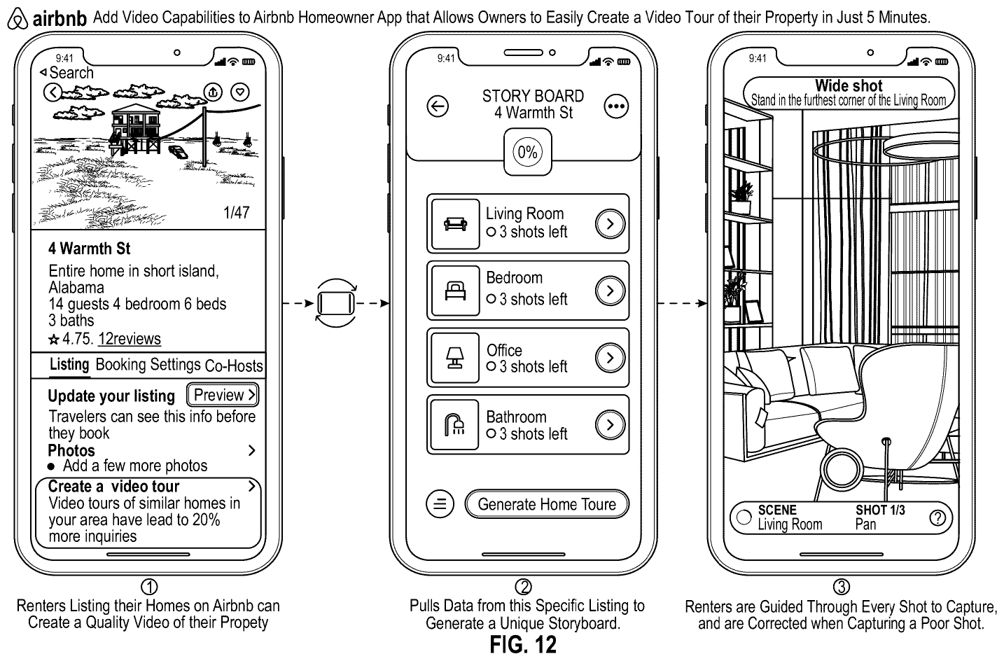

FIG. 14 is an example method 1400 for managing user-generated content that can be performed within the system of FIG. 3 according to the embodiments of the present disclosure. In some embodiments, some or all of the method 1400 can be performed by the server 306 and its various modules.

At step 1402, one or more storyboard templates to be used to guide creation of user-generated content is created. The storyboard templates each include various types of scenes and/or shots where each type of scene and/or shot includes built-in directive prompts to direct the user as to what to capture and what to say. In an optional step, the brand may send a notification to the individual users within the network to urge them to start generating content. The notification may be in form of an SMS, MMS, email, push notification through an application, or any other form of communication sufficient to convey the need to start generating content.

At step 1404, the server 306 and/or another suitable component may transmit, over a network 314, a storyboard template to the frontend 302 to be provided to the user.

At step 1406, the server 306 and/or another suitable component may receive, over a network 314, one or more completed storyboards from the frontend 302. In one or more embodiments, the completed storyboards may be stored in the database 308. In the same or other embodiments, the completed storyboards may be transmitted in a raw form allowing for more seamless video editing by the brand.

At step 1408, the storyboard generation module 304 of system 300 may generate a final video or other presentation containing some or all of the components from the completed storyboards. In some embodiments, the final video may be created from a single completed storyboard while in other embodiments, the final video may be created by selecting particular scenes and/or shots from a first completed storyboard and other particular scenes and/or shots from a second completed storyboard. In a further embodiment, the particular scene or shot may be a trimmed scene so that the final video only contains a portion of the scene or shot. In some embodiments, the final video does not include every scene and/or shot from the completed storyboards. In some embodiments, the generation of the final video may be done automatically through the use of machine learning algorithms or neural networks trained on training datasets including preexisting user-generated content and preexisting final videos created from the preexisting user-generated content. That is, the machine learning algorithm is trained by analyzing the preexisting user-generated content and the preexisting final videos created from said preexisting user-generated content and develops patterns in order to produce similar final videos from new user-generated content. In other embodiments, the generation of the final video may be done manually through a content management system. The content management system may allow the brand to directly edit the scenes and/or shots of each of the completed storyboards.

Machine learning algorithms can play a pivotal role in creating storyboards, for example, by leveraging natural language processing (NLP), generative models, or any other suitable class of machine learning models. In an embodiment, a neural network may be utilized, such as a recurrent neural network (RNN) or a long short-term memory (LSTM) network. These models may be optimized for processing sequential data, making them well-suited for generating coherent and contextually relevant storyboards. By training the algorithm on a vast training dataset of existing storyboards or videos, a suitable model learns the patterns, tone, and structure commonly found in successful storyboards. The machine learning models may adjust prompts based on historical user behavior or brand preferences. The machine learning models may also be configured to support generating storyboards in multiple languages based on the products market.

As contemplated earlier, the process typically involves feeding the model with examples of well-crafted videos and/or storyboards and allowing the model to learn the nuances of effective storytelling and persuasion. Once trained, the model can then generate new storyboards by predicting the next shot, frame, or sequence of audio/visual based on the context it has learned.

As described throughout the disclosure above, the storyboard generation system may be configured for various modes, including but not limited to: (1) manual input (e.g., wherein the system prompts the user on the content of the subject of the video, in effect, allowing the user to manually select the scenes to be included in the video); (2) automatic input with preformatted template (e.g., wherein the system extracts an identifying datapoint from a user's request, such as an MLS identification number, and leverages this information against an online source in order to extract the information necessary for populating one of the one or more preformatted templates); and (3) automatic input with ad hoc templates (e.g., wherein the system extracts an identifying datapoint from a user's request, such as an MLS identification number, and leverages this information against an online source in order to extract the information necessary for creating a storyboard, from the group up, for example, with a machine learning model). However, aspects of the system described throughout the disclosure may be utilized in any of the modes or any other variation of said modes. The aforementioned modes should not be read as limiting, as other variations may exist.

As described herein, the system may utilize at least any of the following schemas for generating storyboards:
Extracting data from elsewhere to automatically generate a storyboard with unique information per said data (e.g., reflected in FIG. 6);
Creating a storyboard manually using a tool that allows the user to enter specific information to generate a unique storyboard (e.g., reflected in FIG. 5);
Using pre-built templates and entering information directly in the interface to generate a storyboard (e.g., reflected in FIGS. 7-8).

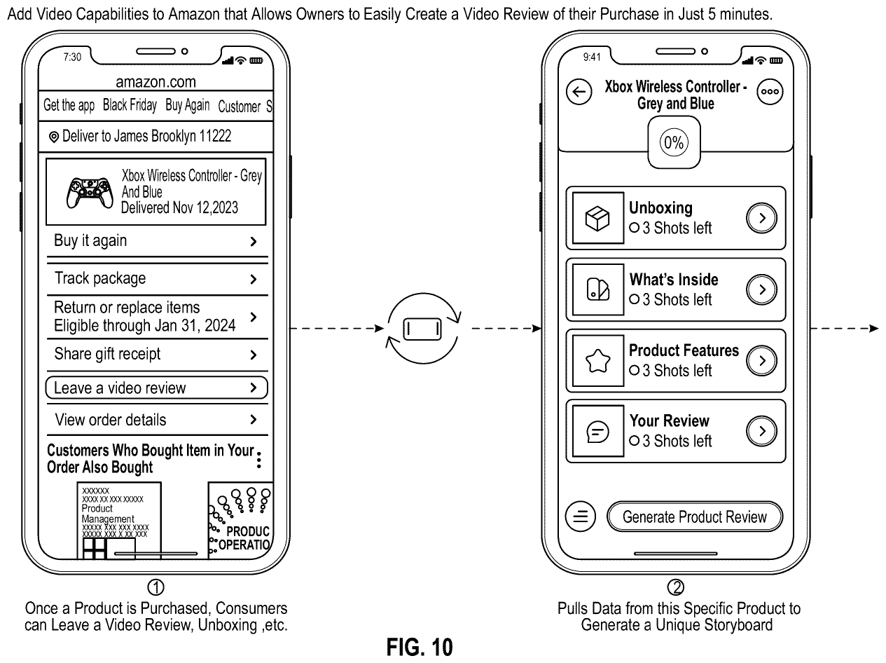

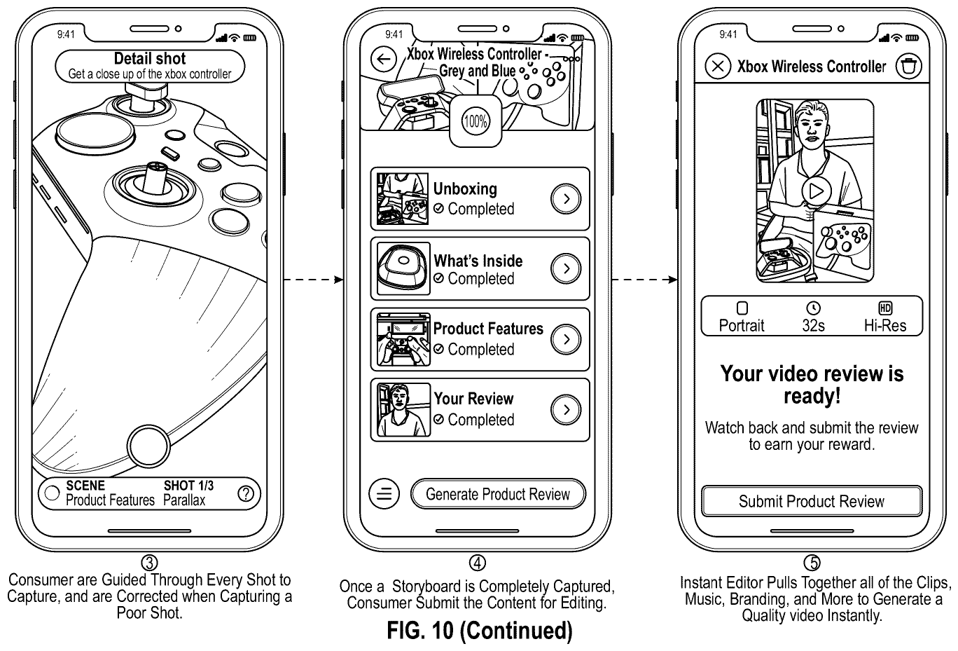

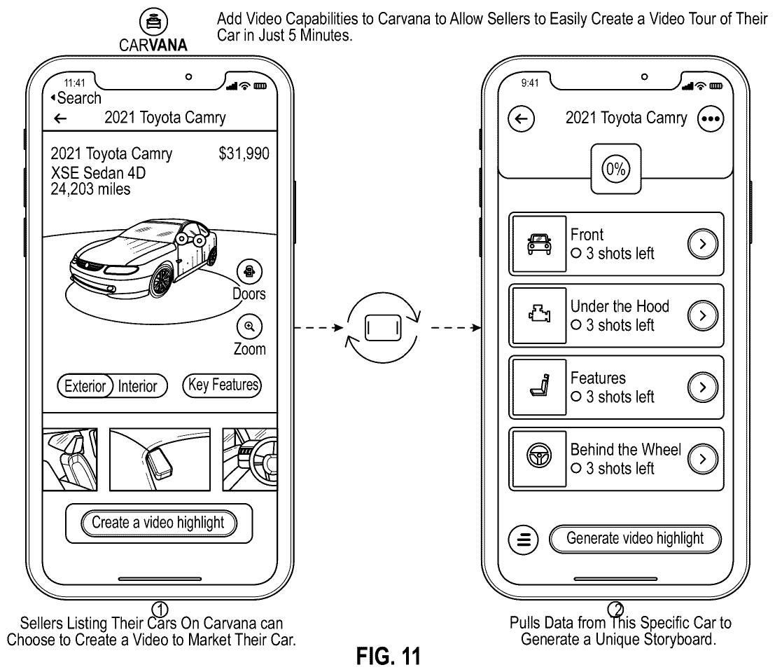

Further, FIGS. 10-12 reflect further embodiments wherein data is extracted from elsewhere to automatically generate a storyboard with unique information per said data.

Referring to FIG. 10, the system may permit addition of video capabilities to ecommerce platforms that allows owners to easily create a video review of their purchase quickly. For example, once a product is purchased, consumers can leave a video review, unboxing, and more. The system may pull data from a specific product to generate a unique storyboard.

The content management system is a centralized hub capable of automatically organizing, tagging, and storing user-generated content. The content management system ensures that marketing teams, content managers, and editors have efficient access to any user-generated content they may need.

When a user generates content, the content is automatically uploaded to the content management system where the content is then automatically tagged with metadata including, but not limited to, the type of storyboard/capture template as well as user, time, and location information. Once the user-generated content is tagged, the content becomes searchable within a database. The brand may locate content using keywords including, but not limited to, “Product Demo,” “Customer Testimonial,” “Outdoor Location,” or the like. The database of content may also be capable of sorting and applying filters. The brand can filter content by parameters like date, user, campaign, or tag. For example, some possible filters may include, but are not limited to, “Clips from the September launch campaign” or “Videos featuring employees.”

In one or more embodiments, the server 306 may include a data retrieval layer. This layer may interface with public APIs of external e-commerce platforms (e.g., Amazon Product Advertising API) to retrieve product data. APIs provide structed product data including, but not limited to, titles, images, key features, product descriptions, technical details, variations and attributes. Example interfaces and APIs can be found in FIGS. 19-23. If an API is unavailable or access is restricted, the server 306 may employ web scraping tools such as scraping HTML data to clean and structure text, removing irrelevant sections and extracting meaningful insights for storyboarding. Scraping retrieves data from publicly visible parts of the product listing page (e.g., title, description, reviews). Further, the server may be configured to monitor changes in APIs in real-time to constantly update storyboards as needed or to flag missing or incomplete data, triggering fallback mechanisms to fetch supplementary details. The system may include a Large Language Model (LLM) capable of preprocessing API responses to extract contextually relevant information, prioritizing details critical to storyboard generation (e.g., key features, benefits, and brand tone). For platforms without APIs, the LLM may analyze scraped HTML data to clean and structure text, removing irrelevant sections and extracting meaningful insights for storyboarding.

Once product data is retrieved, it may be normalized and parsed for use in storyboard generation. Extracted fields (e.g., title, description, key features) are mapped to a predefined schema that matches the storyboard framework. For example, the title may be mapped to the storyboard headline, key features may be mapped to prompts or tags, and images may be mapped to reference visuals for end-users. Natural Language Processing (NLP) algorithms may analyze textual descriptions to identify product keywords, use cases or scenarios, or brand messaging. Sentiment analysis may also be applied to customer reviews for potential inclusion in storyboards. AI models may categorize content based on attributes such as industry, target audience, and style (e.g., technical vs. lifestyle focus). LLMs and other AI tools may be implemented to transform raw data into structured and meaningful inputs for storyboard generation. LLMs may adapted to enhance product descriptions by summarizing verbose text into concise, action-oriented prompts for storyboards. For example, a long product description for a coffee maker is condensed into “Show the brewing process” or “Highlight the sleek stainless-steel finish.” The server or system 300 may leverage product taxonomies (e.g., “electronics,” “apparel”) and knowledge graphs to contextualize attributes and suggest relevant capture scenarios. For example, identifying “noise-cancelling” as a critical feature of headphones to generate a storyboard prompt like “Demonstrate noise reduction in a busy setting.” The server may analyze customer reviews to extract user sentiment and feature mentions, guiding storyboard prompts that resonate with consumer priorities. For example, positive reviews highlighting ease of use could translate into “Capture a first-time setup demonstration.” The server may use clustering algorithms to group similar products and map them to the most effective storyboard templates, saving time in manual assignments.

The storyboard generation module 304 transforms parsed and normalized data into structured storyboards. The data may be matched against predefined storyboard templates relevant to the product's industry. For example, a product in the electronics category might map to a “Product Demo” template while a product in apparel might map to a “Fashion Lookbook” template. Prompts may be dynamically generated based on the extracted data. For example, the prompt “Show how this feature works” may indicate for the user to show key features while the prompt “Highlight the product's packaging” may prompt the user to show an image of the product. The prompts ensure consistency with the product's description and brand tone. The storyboard generation module may further suggest visuals as reference shots and a teleprompter feature may be pre-loaded with script suggestions derived from product descriptions.

The server's LLM may generate specific, actionable prompts based on product descriptions, ensuring high relevance. For example, a product description like “lightweight and durable hiking boots” may translate into prompts such as “Highlight the flexibility of the sole on rough terrain” or “Show the boots in action on a rocky trail.” The LLM may craft teleprompter scripts tailored to the product's tone and audience, using a brand's style guide to ensure consistency. For example, a luxury brand may include, “Emphasize premium craftsmanship with close-up shots.” The server may be configured to use vision-based AI models (e.g., CLIP) to analyze product images to suggest complementary visual cues for video captures, like camera angles or color pairings. The machine learning algorithm may analyze product data to automatically match products with the most relevant storyboard templates. For example, the system may identify a gadget fits into a “Product Demo” category versus a “Lifestyle Use” category. Furthermore, the use of AI generation allows for more personalized storyboards to meet user-specific needs and preferences. Machine learning models may analyze user preferences and historical behavior (e.g., preferred shot types or styles) to tailor storyboard templates. Fine-tuned LLMs may incorporate brand-specific tone, style, and messaging guidelines into generated prompts and scripts. The LLM may provide multilingual capabilities, dynamically translating storyboards into the user's preferred language while preserving the brand voice and preferences.

The server 306 may further be capable of content synchronization. The generated storyboards may be sent to a mobile or web application for user interaction. The storyboard is synchronized with the user's application interface, displaying the generated prompts and guidance. If product data changes (e.g., a new feature is added), the storyboard may be automatically updated through API/webhook communication. The AI may allow real-time user interaction for collaborative edits with storyboards, dynamically adjusting based on feedback or changes to product data. The server 306 may be capable of offering real-time suggestions during video capture, such as refining angles or emphasizing key product features. For example, during a capture session, the app might suggest, “Adjust lighting to reduce shadows on the product.” In an embodiment, preemptive directives within a scene may be generated before capture begins, in effect, to allow a user to set up or prepare for the shot or arrange the setting.

The server's backend architecture ensures seamless communication and data management. Separate services may handle API communication, data parsing, and storyboard generation. Services may communicate via REST APIs or gRPC within the backend. Product data and generated storyboards may be stored in a relational database (e.g., PostgreSQL) for structured storage and retrieval. Metadata may be cached in systems like Redis for faster access. Metadata tagging may be automated using AI, ensuring efficient filtering and retrieval. The server may use containerized environments (e.g., Docker, Kubernetes) to scale the storyboard generation module based on demand. The system's 306 use of AI and LLMs may allow for scalability and intelligence. Scalable AI infrastructure (e.g., Kubernetes clusters with GPU support) may ensure LLMs and machine learning models can handle large volumes of requests during peak usage. The LLM may preprocess and enrich incoming product data before storage in the relational database 308.

The AI and machine learning systems may continuously learn and improve based on user interactions and outcomes. The system 300 may utilize feedback loops to have finalized storyboard outcomes (e.g., video engagement rates) feed back into AI models to refine prompt generation and template selection. Machine learning may run experiments on storyboard variations to identify the most effective formats for specific products or industries. The machine learning models may predict the most effective storyboard styles based on product category, target audience, and past success metrics. The LLM may be autotuned based on product categories, user preferences, or new data, ensuring relevance over time. The system 300 may incorporate generative AI (e.g., DALL·E) to generate placeholder visuals for storyboard concepts before user-generated content is captured. The system may provide instant feedback on captured videos for lighting, framing, or speech clarity. LLM-powered voice assistants may guide users through the capture process, enhancing usability.

The server may be configured to adhere to platform-specific policies (e.g., Amazon's terms of service) and avoid storing sensitive user data beyond permissible limits. Further, the server may be configured to use encrypted communication protocols (e.g., HTTPS) for API requests.

The server may preprocess and enrich incoming product data before storage in the application's relational databases. The server may automatically tag metadata.

An ecommerce product listing page is structured to provide detailed information about a product, helping customers make informed purchasing decisions. As nonlimiting examples, the key parts of an ecommerce product description and information on a product listing page are as follows:
1. Title
   Purpose: A concise yet descriptive summary of the product.
   Key Elements:
      Brand name
      Product type
      Key features (e.g., size, color, quantity, or variant)
      Specific model or SKU information.
   Example: “XYZ Wireless Bluetooth Headphones, Noise-Cancelling, Over-Ear, Black”
2. Images
   Purpose: Visual representation of the product to enhance appeal and clarity.
   Types of Images:
      Primary image (main product shot on a white background)
      Alternate views (different angles or features)
      Lifestyle images (product in use)
      Infographics (highlighting key features/specifications)
      Size or dimension charts (if applicable)
      Video (optional)
3. Key Features (Bullet Points)
   Purpose: Highlight the most important aspects of the product in an easy-to-read format.
   Typical Features Covered:
      Product benefits
      Material or construction
      Size, weight, or dimensions
      Compatibility or special uses
      Unique selling points (e.g., warranties, certifications)
   Best Practices: Use up to 5 bullets, each starting with a capitalized keyword and structured concisely.
4. Product Description
   Purpose: Provide a detailed narrative about the product's use, features, and benefits.
   Key Components:
      Introduction to the product
      Expanded details on features and functionality
      Customer benefits and use cases
      Differentiation from competitors
      Any necessary disclaimers or certifications (e.g., safety warnings)
   Often formatted with HTML for better readability, such as bolded text or line breaks.
5. Product Variations
   Purpose: Allow customers to choose among different versions of the product.
   Examples of Variations:
      Colors
      Sizes
      Styles
      Quantities
6. Price and Availability
   Purpose: Provide pricing details and stock status.
   Information Displayed:
      Current price (including discounts or promotions)
      Shipping costs and delivery options (Prime eligibility, estimated delivery dates)
      Stock availability (e.g., “In Stock,” “Only 5 Left”)
7. Customer Reviews and Ratings
   Purpose: Showcase feedback and social proof from previous buyers.
   Key Elements:
      Average star rating (out of 5)
      Total number of reviews
      Highlighted customer reviews (with images or videos from buyers, if available)
      Searchable review filters (e.g., “Most Recent,” “Verified Purchase”)
8. Technical Details (Product Specifications)
   Purpose: Provide granular data for technical or feature-focused shoppers.
   Information Typically Included:
      Dimensions and weight
      Material or composition
      Technical specs (e.g., power requirements, resolution, capacity)
      Manufacturer details (e.g., brand name, model number, or SKU)
9. About This Item (Highlight Section)
   Purpose: Brief overview of the product's most compelling features.
   Placement: Often located just below the title or main image.
10. Additional Sections
   A+ Content (Enhanced Brand Content):
      Rich visuals, comparison charts, or brand storytelling.
      Available only to brand-registered sellers.
   What's in the Box:
      Lists items included with the purchase (e.g., accessories, manuals).
   Frequently Bought Together:
      Cross-sells or related products often purchased with the item.
   Product Comparison Table:
      Displays how this product compares to others in the seller's lineup.
11. Seller Information
   Purpose: Introduce the seller or brand and offer transparency.
   Details Included:
      Seller name and rating
      Return and refund policy
      Contact information (if available)
12. FAQs (Customer Questions & Answers)
   Purpose: Address common queries about the product.
   Details:
      Customer-submitted questions and seller/community answers.
13. Related and Recommended Products
   Purpose: Upsell or provide alternatives to increase conversions.
   Sections:
      “Customers who bought this also bought”
   “Products related to this item”
14. Shipping and Warranty Information
   Purpose: Inform customers about delivery options, warranty terms, or guarantees.
   Displayed As:
      Estimated delivery times
      Warranty details (manufacturer warranty, extended plans)
15. Legal and Safety Information
   Purpose: Meet regulatory requirements or provide safety disclaimers.
   Examples:
      Hazard warnings for certain products
      Licensing or compliance certifications
16. Variants or Configurations
   Purpose: Showcase other configurations of the same product (e.g., bundles, refurbished options).

The AI may ensure compliance with data privacy and security regulations. User data may be anonymized before analysis by AI models. Encrypted communications may protect sensitive API interactions. AI modules may comply with platform-specific data usage policies and legal regulations (e.g., GDPR, CCPA).

### Examples

The following is a list of example “brands” and how they each may utilize the system described in the present disclosure.

### E-Commerce

E-commerce brands may use the content management system to request and collect user-generated content from customers and influencers, showcasing product reviews, unboxings, and how-to videos. Employees may also create content highlighting new product launches or behind-the-scenes manufacturing processes.

Example: A skincare brand may guide customers to record videos showing their morning routine featuring the brand's products, which may be automatically uploaded and categorized into the content management system for marketing use.

Example: A brand selling a premium espresso machine wants to generate user-created promotional videos. The server pulls product details (key features) like “sleek stainless-steel design,” “15-bar pressure,” and “removable milk frother” from the e-commerce listing. Images of the espresso machine and user reviews mentioning “easy to use” are also captured. Storyboard Generation:
Prompt 1: “Show how you unbox your espresso machine and highlight its stainless-steel finish.”
Prompt 2: “Demonstrate making a cappuccino, focusing on the milk frother.”
Prompt 3: “Capture a close-up of the espresso pouring process to highlight the crema.”
Prompt 4: “Film yourself enjoying a cup and sharing your thoughts.”

User Experience: Users follow step-by-step prompts, guided by server's teleprompter and visual cues. Captured videos are automatically tagged and organized for the marketing team.

### Universities

Universities may use the content management system to create videos showcasing campus life, alumni success stories, student testimonials, and faculty highlights. Event-based templates may be used to capture graduation ceremonies, homecoming celebrations, or sports events.

Example: A university may guide current students to capture day-in-the-life videos to attract prospective students, emphasizing the academic and extracurricular experience.

### Auto Dealerships

Auto dealerships may use the storyboard generation system to create walkaround videos of new vehicle inventory, customer testimonials, and promotional content for sales events. Sales reps may record dynamic clips demonstrating vehicle features and benefits.

Example: A dealership may create a storyboard template prompting sales reps to capture a 360-degree view of each new car, highlighting key features like advanced safety systems and infotainment options.

### Real Estate Agents

Real estate agents may use the storyboard generation system to create guided property tours, client testimonials, and local neighborhood highlight videos. This may help agents efficiently showcase listings to save time and effort.

Example: An agent could follow the storyboard template to film a property walkthrough, narrating features like the open floor plan, modern kitchen, and backyard amenities, all aligned with the agency's branding.

Example: A real estate brokerage wants agents to create property walkthrough videos for online listings. The system integrates with the MLS or brokerage database to retrieve property details such as “3-bedroom townhouse,” “modern kitchen,” “spacious backyard,” and “energy-efficient appliances.” Pulls staged photography and descriptions from the property listing.

### Storyboard Generation

Prompt 1: “Film the entrance of the property, focusing on curb appeal.”
Prompt 2: “Showcase the modern kitchen by highlighting the countertops and appliances.”
Prompt 3: “Capture the backyard space and emphasize its potential for entertaining.”
Prompt 4: “Narrate a walkthrough of the master bedroom and its en-suite bathroom.”

User Experience: Agents follow prompts to record footage with guided framing and narration tips. Videos are uploaded, tagged, and ready for marketing teams to include in digital listings.

### Fitness Studios

Fitness studios may create engaging content for social media, such as trainer spotlights, workout demonstrations, and member testimonials. Event templates may capture special classes or promotions.

Example: A fitness studio may guide trainers to record workout tutorials or motivational clips, while members might be prompted to share their fitness transformations.

### Cruise Lines

Cruise lines may use the storyboard generation system to gather content from passengers and crew showcasing onboard experiences, destinations, and activities. Employees may capture behind-the-scenes operations, while customers may share personal vacation highlights.

Example: Directive prompts may guide crew members to record videos of onboard amenities, like the spa or pool deck, while passengers might capture videos of excursions or dining experiences.

### Restaurants

Restaurants may use the storyboard generation system to create content highlighting new menu items, chef interviews, customer testimonials, and special events. Customers may also contribute videos sharing their dining experience.

Example: A restaurant might guide customers to record videos describing their favorite dish or cocktails, while chefs could use the storyboard generation system to capture a behind-the- scenes look at meal preparation.

Example: A restaurant wants to showcase its signature dishes and dining experience to attract more customers. The server integrates with the restaurant's menu data and highlights items tagged as “chef's favorites” or “most popular,” such as “Spicy Tuna Roll” or “Truffle Mac & Cheese,” and pulls customer reviews and existing social media photos of dishes.

### Storyboard Generation

Prompt 1: “Show the Spicy Tuna Roll being plated by the chef in the kitchen.”
Prompt 2: “Film a customer enjoying the Truffle Mac & Cheese with their reaction.”
Prompt 3: “Capture the ambiance of the restaurant, focusing on lighting and decor.”
Prompt 4: “Highlight the cocktail bar and a bartender creating a signature drink.”

User Experience: Staff or customers use the application to film behind-the-scenes shots or testimonials. Content is aggregated and edited into a social-ready format for Instagram or TikTok.

### Hotels and Resorts

Hotels and resorts may collect guest testimonials, showcase amenities, and capture event footage. Staff may create videos about local attractions or behind-the-scenes preparations for guests.

Example: A resort might use the storyboard generation system templates to guide staff in creating videos of spa services or room tours, while guests may share clips of their stay, like enjoying the pool or dining at an on-site restaurant.

Example: A cruise line wants to highlight onboard activities and excursions to attract new travelers. The system pulls data from the cruise line's itinerary, focusing on activities like “zip-lining on private islands,” “poolside yoga,” and “sunset dining experiences,” and gathers customer testimonials and promotional materials from previous voyages.

### Storyboard Generation

Prompt 1: “Capture the excitement of zip-lining on the private island.”
Prompt 2: “Film a serene moment during the poolside yoga session.”
Prompt 3: “Show a chef preparing a gourmet meal for the sunset dining experience.”
Prompt 4: “Interview a passenger about their favorite activity onboard.”

User Experience: Passengers or crew use the mobile application to create structured video content during the cruise.

### Retail Stores

Retail stores may create content featuring new collections, in-store events, and customer testimonials. Employees may capture videos of store layouts or seasonal promotions.

Example: A clothing retailer may guide staff to record styling tips for new arrivals or customer testimonials highlighting their shopping experience. Marketing teams access polished clips for campaigns promoting future sailings.

### Municipalities

Municipalities may use the storyboard generation system to document community events, share resident testimonials, and promote local attractions or initiatives. Staff may create informational videos for public awareness campaigns.

Example: A city might guide residents to record videos sharing what they love about living in their community, while staff captures highlights from festivals or local events.

### Journalists

Journalists may use the storyboard generation system to gather on-the-ground footage, interviews, and real-time reporting. Newsrooms may also request audience-generated content for stories requiring community perspectives.

Example: The storyboard generation system may guide journalists to capture interviews with key sources or footage of live events, ensuring high-quality clips for quick turnaround in news reports.

### Professional Sports Teams

Sports teams may collect fan-generated content from games, showcase player interviews, and capture behind-the-scenes moments. Marketing teams may use the storyboard generation system to streamline content creation for social media and promotional campaigns.

Example: A team might guide fans to record videos celebrating a big win or create prompts for players to capture personal insights into their training routines and game-day experiences.

The guided capture experience and centralized content management system provide each industry with tailored tools to create authentic, high-quality content efficiently.

### Individual-Focused Examples

### Employee

Employees may use the guided capture system to capture behind-the-scenes content, team highlights, or workplace culture videos. For example, a retail associate might record a tour of a new store display, or a technician might document the process of a service being performed.

### Contractor

Contractors may use the guided capture system to create content tied to their specific expertise. For instance, a freelance photographer might use the guided capture system to shoot branded product videos, or a real estate agent might capture property tours using the guided templates.

### Fans of a Brand

Fans may use the guided capture system to share authentic user-generated content, such as showcasing how they use the brand's products in their daily lives. For example, a sports fan might record their experience wearing branded gear at a game.

### Brand Ambassador

Brand ambassadors may use the guided capture system to create promotional content, such as unboxing videos, testimonials, or event coverage. The ambassador may follow specific prompts to ensure the content aligns with the brand's campaigns while maintaining their personal style.

### Customer

Customers may use the guided capture system to share their experiences, reviews, and stories about the brand. For example, a customer might record a video about their favorite feature of a product or their satisfaction with a service, contributing to the brand's user-generated content library.

### Influencer

Influencers may use the guided capture system to capture sponsored content with detailed guidance to ensure it meets campaign requirements. This may include tutorials, product endorsements, or event coverage designed to resonate with the influencer's audience.

### Sales Representative

Sales representatives may use the guided capture system to create dynamic sales enablement content, such as product demos, client success stories, or walkthroughs of solutions. This content helps the sales representative personalize their pitches and engage potential customers more effectively.

Each persona may use the guided capture system to create content that serves their unique role within the brand's network. The guided prompts and streamlined workflows ensure that every user can produce high-quality, brand-aligned content, whether they are an employee promoting workplace culture, a customer sharing a heartfelt review, or a sales representative highlighting key product features.

In some aspects, the techniques described herein relate to a system, the computer-executable server instructions which, when executed by the at least one server processor, cause the server network to generate a storyboard on the network server, wherein the storyboard is passed through to the frontend.

In effect, the methods and systems described herein provide for improvements to automated video editing technologies. In some embodiments, the methods and systems herein are fueled by: (1) machine learning techniques to generate a storyboard template complete with scenes and directives thereof, wherein the scenes and directives are personalized to the underlying content (product review, real estate listing, etc.); (2) real-time directed video capture influenced by (a) the aforementioned personalized scenes and directives, and (b) corrective hardware-informed feedback configured to optimize video capture quality. Yet further, the corrective feedback may be content-specific in that each scene and the desired scene characteristics (personalized in view of the content) may dictate the various corrective feedback thresholds (e.g., acceptable light, ambient noise, excessive frontend 302 movement). Thus, the underlying content data may indirectly influence the captured media.

In addition to, or separately from, the elements and steps as described herein, the system 300 may perform the method 400 illustrated in FIG. 4 by first executing step 402. Step 402 may include collecting user-specific data from the user. As a non-limiting example, the user specific data may include the user's employment information, social media information, or other digitally available information that may be pertinent to generating a customized storyboard template catered to the user's information (e.g., a real estate storyboard template may be generated for users whose information indicates they work in the real estate industry). As a further example, “user-specific data” may include information manually input from the user indicating a preference for a specific category of storyboard template, such as a storyboard template related to a vehicle listing. Alternatively, the “user-specific data” may be automatically extracted and/or processed.

The system 300 may obtain user-specific information via one or more APIs. In such an embodiment, the system 300 may communicate with one or more third party services via such APIs. For example, the system 300 may determine, via the one or more APIs, that the user is a real estate agent with specific properties listed on the third-party service. As such, the system 300 may receive user-specific information such as the address of the property, the number of bedrooms, the number of bathrooms, the square footage of the property, or any other relevant information. Other use cases outside of the real estate example are also contemplated. For example, the system 300 may receive information relating to the user's hobbies, career, religion, or other category of information as may be relevant to generating storyboard content.

In an embodiment, the story board generation module 304 incorporates LLMs and other AI/ML facilities, for example, to enhance automation, intelligence, and personalization. As discussed above, the system 300 may be configured for data retrieval. The combination of steps and elements that facilitate data retrieval may be referred to as the data retrieval layer. This layer may interface with, for example, external ecommerce platforms to retrieve product data. The API integration, as discussed above, may be utilized with AI-driven data parsing. As a nonlimiting example, LLMs like GPT models may be utilized to preprocess API responses to extract contextually relevant information, prioritizing details critical to storyboard generation (e.g., key features, benefits, and brand tone). In conjunction with or instead of AI-integration, the system 300 may utilize web scraping with NLP enrichment. Accordingly, for platforms without APIs, LLMs may be implemented to analyze scraped HTML data to clean and structure text, removing irrelevant sections and extracting meaningful insights for storyboarding. In an embodiment, the data retrieval layer may include real-time AI monitoring. Such real-time AI monitoring may facilitate machine learning monitoring of APIs and/or scraping responses to flag missing or incomplete data, triggering fallback mechanisms to fetch supplementary details (for example, to further support generation of a given storyboard template).

At step 404, the system 300 may monitor third-party services for data via one or more APIs. For example, a user may link their accounts with third-party services to the system 300 via said APIs. As such, data may be pushed to the system 300 for further processing.

At step 406, the 300 may format the data input from steps 402 and 404. At step 406, the server 306 or another suitable component may format the content and/or user-specific data into an input readable for the storyboard generation module 304. Prior to the generation of storyboard templates, the content may be preprocessed. The content and/or user-specific data may undergo a cleaning process to rectify inconsistencies and eliminate inaccuracies, ensuring the integrity of the ensuing storyboard. Subsequently, a structured categorization of the content and/or user-specific data may facilitate the organization of information for coherent template generation. For example, information that is superfluous may be scrubbed during step 406. Further, missing and/or necessary information may be flagged and/or replaced (e.g., inserted with the likely value as determined by generative AI or another similar technique). Additionally, the normalization and standardization of data formats may be implemented. In another embodiment, an iterative validation process may be used to verify the accuracy of the preprocessed data, thus laying a robust foundation for the subsequent creation of meaningful and visually compelling storyboard templates.

At step 408, data from step 406 may be fed into the storyboard generation module 304. The storyboard generation module 304 may then process the data during step 410 to then generate a storyboard template at step 412.

During step 410, the storyboard generation module 304 may determine various parameters of the storyboard template. These parameters may include how many suggested scenes the storyboard will include, what category each storyboard scene will cover, the desired shot styles of each scene, or any other suitable parameter. These parameters may be manually set, or may be determined automatically via artificial intelligence.

In an embodiment utilizing artificial intelligence, the artificial intelligence may comprise a machine learning algorithm trained with a training dataset including previously recorded content of varying subject matter (e.g., real estate, technology products, sport, religion, etc.). As such, the machine learning algorithm may determine what categories of content (e.g., location information, sport team milestones, religious tenets, etc.) are commonly used for each area of subject matter. The machine learning algorithm may use the same methodology to determine other most commonly used parameters.

Once the parameters of the storyboard template have been determined. The storyboard generation module 304 may generate a storyboard template at step 412. Said storyboard template may be sent to the frontend 302 to be interacted with by the user. Which may appear to the user as shown in FIG. 6. Referring to FIG. 6, the storyboard generation module 304 may reads large sets of data to automatically generate hyper-specific storyboards to empower consumers and influencers to capture video content for the products they use and the brands they enjoy.

FIG. 6 includes a series of examples of how the storyboard template may appear to the user depending on the information input to the storyboard generation module 304 from steps 402 and 404. For example, if said information includes data relating to a travel itinerary, the storyboard generation module 304 may populate the storyboard template with several suggested scenes including, for example, a trail head scene, a tavern scene, a devil's cover scene, an airstream scene, and a campground scene. Similarly, if the information from steps 402 and 404 relate to a real estate property, the suggested scenes may include a scene of each room (or the most importantly filmed rooms as determined by a machine learning element) of the house as exemplified in FIG. 6.

During step 414, the user may select each suggested scene to populate the storyboard template with user content. In such an embodiment, the system 300 may determine whether such content satisfies the one or more parameters of each scene as determined during step 410. The number of parameters satisfied may result in a completion percentage of that scene (e.g., 0-100%) as shown in FIG. 6. An overall completion of the storyboard corresponding to the percentage of all parameters met may be displayed to the user as also shown in FIG. 6.

At step 416 the user may manually add scenes to the storyboard, and may manually set their own parameters for each scene.

At step 418, once all parameters have been satisfied, and the user has added their non- suggested scenes, if any, the system 300 may then generate the storyboard as described herein.

These and other aspects, features, and advantages of the present disclosure will become more readily apparent from the following drawings and the detailed description of the preferred embodiments.

The workflow described herein may be executed and/or used in connection with any suitable machine learning, artificial intelligence, and/or neural network methods. For example, the machine learning models may be one or more classifier and/or neural network. However, any types of models may be utilized, including regression models, reinforcement learning models, vector machines, clustering models, decision trees, random forest models, Bayesian models, and/or Gaussian mixture models. In addition to machine learning models, any suitable statistical models and/or rule-based models may be used. The benefits of using machine learning for screenplay generation may include increased efficiency, as it can quickly generate multiple storyboards with the potential for discovering novel and compelling messaging that may not have been apparent through traditional drafting methods. As described above, use of machine learning allows for customization based on target demographics and market trends, optimizing the video's impact on the intended audience.

In various embodiments, the system described herein may be implemented in preexisting applications or systems. As a nonlimiting example, the storyboard generation system described herein may be built into a content-focused social media application, permitting a user to begin recording a video or begin the posting process, shortly thereafter to be given the option of utilizing the storyboard generation system. Accordingly, a storyboard may be provided within such a third-party remote computing environment in order to improve the quality of content and posts that a user would other have sole storyboard control over. In such an embodiment, the storyboard generation system may retrieve information from the user's account on said social media application.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the claims.

Although the term “one or more” may often be used in the specification, claims, and drawings, the terms “a,” “an,” “the,” “said,” etc. also signify “one or more” in the specification, claims, and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method for generating a storyboard, the method comprising:
generating, via a server, a storyboard template comprising one or more suggested scenes, wherein each suggested scene of the one or more suggested scenes comprises at least one directive prompt;
transmitting, via a network, the storyboard template to a frontend;
capturing, based on the storyboard template comprising the one or more suggested scenes, content on the frontend, wherein the content comprises the one or more suggested scenes;
receiving, at the server, the content comprising the one or more suggested scenes; and
generating, based on the content comprising the one or more scenes, a storyboard.

2. The method of claim 1, wherein the method further comprises transmitting, via the server, a notification to the frontend instructing a user to configure the frontend to capture the content.

3. The method of claim 1, the step of generating, based on the content comprising the one or more scenes, a storyboard further comprising utilizing a machine learning algorithm to generate the storyboard, wherein the machine learning algorithm is trained on a training dataset selected from a group comprising preexisting content and preexisting storyboards generated from the preexisting content.

4. The method of claim 3, wherein the machine learning algorithm is further trained based on historical user behavior and/or predefined brand preferences.

5. The method of claim 1, wherein the frontend comprises a display, and wherein the display is configured to display guardrail settings to the user, the guardrail settings comprising a directive prompt and a corrective prompt.

6. The method of claim 5, wherein the method further comprises:
tracking data of a hardware component of the frontend, the hardware component comprising any of an accelerometer, a gyroscope, a microphone, and a light sensor;
determining, based on the data of the hardware component, the scene of the one or more scenes is not within a threshold of the guardrail settings;
displaying on the display the corrective prompt.

7. The method of claim 1, wherein the frontend automatically transmits the content to the server when the content is generated.

8. A method for directing the capture of user content, the method comprising:
transmitting, via a network, a storyboard template to frontend, the storyboard template comprising a plurality of suggested scenes, wherein each suggested scene of the plurality of suggested scenes comprises guardrail settings, the guardrail settings for each of the suggested scenes comprising:
one or more directive prompts configured to direct a user in capturing content; and
a plurality of corrective prompts;
monitoring the frontend, wherein the frontend is actively capturing user content;
determining the user content being captured by the frontend is outside a threshold of the guardrail settings; and
displaying, in response to determining the user content is outside the threshold of the guardrail settings, on a display of the frontend at least one corrective prompt of the plurality of corrective prompts.

9. The method of claim 8, the method further comprising transmitting, to the frontend, a notification comprising directions to begin capturing the content of a subject.

10. The method of claim 8, wherein the guardrail settings further comprise any of a shot style, a shot view, a camera choice, a script, a suggested scene order, a maximum recording length, an acceleration, an orientation, a light level, and a sound level.

11. The method of claim 8, wherein monitoring the frontend actively capturing user content comprises monitoring any of an accelerometer, a gyroscope, a light sensor, and a microphone of the frontend.

12. The method of claim 11, wherein at least one corrective prompt of the plurality of corrective prompts is configured to be displayed on the frontend upon the gyroscope detecting the frontend being tilted beyond the threshold of the guardrail settings.

13. The method of claim 11, wherein at least one corrective prompt of the plurality of corrective prompts is configured to be displayed on the frontend upon the accelerometer detecting the frontend is experiencing an excess of movement.

14. The method of claim 11, wherein at least one corrective prompt of the plurality of corrective prompts is configured to be displayed on the frontend upon the light sensor detecting an ambient light being too low.

15. The method of claim 11, wherein at least one corrective prompt of the plurality of corrective prompts is configured to be displayed on the frontend upon the microphone detecting an ambient noise level being too high.

16. A method for generating a final video based on user-generated content, the method comprising:
transmitting, via a network, a plurality of storyboard templates comprising a plurality of suggested scenes, wherein each suggested scene of the plurality of suggested scenes comprises a directive prompt configured to communicate scene capturing directions;
receiving, at a server, a plurality of complete storyboards comprising a first complete storyboard and a second complete storyboard, wherein each complete storyboard of the plurality of complete storyboards comprises a plurality of scenes of user-generated content based on the directive prompts;
storing the plurality of complete storyboards in a content management system;
generating, via the content management system, a final video comprising at least a portion of a first plurality of scenes of user-generated content of the first complete storyboard and at least a portion of a second plurality of scenes of user-generated content of the second complete storyboard.

17. The method of claim 16, wherein the content management system comprises a machine learning algorithm configured to automatically generate the final video, wherein the machine learning algorithm is trained on a training dataset selected from a group comprising preexisting scenes and preexisting complete storyboards generated from the preexisting scenes.

18. The method of claim 17, wherein the method is repeated to create a plurality of final videos from corresponding completed storyboards, and wherein machine learning algorithm is further trained on the plurality of final videos and the corresponding completed storyboards.

19. The method of claim 16, wherein the final video comprises at least a first portion of the plurality of scenes of a first complete storyboard of the plurality of storyboards and at least a second portion of the plurality of scenes of a second complete storyboard of the plurality of storyboards.

20. The method of claim 16, wherein the final video comprises a trimmed scene, wherein the trimmed scene comprises a portion of a first scene of the plurality of scenes.
